(19) United States
(12) Patent Application Publication
(10) Pub. No.: US 2015/0050626 A1
(43) Pub. Date: Feb. 19, 2015

(54) Systems, Methods, and Software for Improving Cognitive and Motor Abilities

(71) Applicant: Dart NeuroScience, LLC, San Diego, CA (US)

(72) Inventor: Timothy Tully, Solana Beach, CA (US)

(21) Appl. No.: 14/213,931

(22) Filed: Mar. 14, 2014

Related U.S. Application Data
(60) Provisional application No. 61/798,732, filed on Mar. 15, 2013.

(51) Int. Cl. G09B 19/00

(52) U.S. Cl. CPC G09B 19/00
USPC 434/236

(57) ABSTRACT

Systems and methods for treating patients to improve cognitive or motor abilities are disclosed. One exemplary method comprises receiving a visiting patient at a clinic, administering an augmenting agent to the visiting patient, training the visiting patient to stimulate neuronal activity, and recording augmenting agent administration data and patient training data associated with the visiting patient. The augmenting agent may comprise a phosphodiesterase 4 (PDE 4) inhibitor. The method may further comprise receiving a returning patient at the clinic, administering the augmenting agent to the returning patient, training the returning patient to stimulate neuronal activity, and recording augmenting agent administration data and patient training data associated with the returning patient.

The present application claims the benefit under 35 U.S.C. §119(e) to U.S. Application No. 61/798,732, filed Mar. 15, 2013, which is hereby incorporated by reference in its entirety.

### FIELD OF THE INVENTION

The present inventions relates to clinics, systems, methods, software programs, and digital devices for improving cognitive or motor abilities, including those based on the use of augmenting agents in conjunction with training protocols.

### BACKGROUND OF THE INVENTION

Cognition, or cognitive function, is the process by which an individual acquires, retains, and uses knowledge. It is broadly represented throughout the brain, organized into different domains that govern numerous cognitive processes, including attention, learning, memory, language, speech, as well as executive functions such as planning, organizing, sequencing, and abstracting.

Cognitive dysfunction occurs in an estimated 4 to 5 million Americans, representing 2 percent of all ages and about 15 percent of those older than age 65. Such dysfunction is typically manifested by one or more cognitive deficits, including memory impairments (impaired ability to acquire new information or to recall previously stored information), aphasia (language/speech disturbance), apraxia (impaired ability to carry out motor activities despite intact motor function), agnosia (failure to recognize or identify objects despite intact sensory function), and disturbances in executive functioning (i.e., planning, organizing, sequencing, abstracting).

Cognitive impairments are present in a wide array of neurological conditions and disorders, including age-associated memory impairments, neurodegenerative diseases, psychiatric disorders, trauma-dependent losses of cognitive function, genetic conditions; mental retardation syndromes, and learning disabilities. Consequently, cognitive dysfunction can significantly interfere with social or occupational functioning, perturbing an individual's ability to perform activities of daily living and greatly impacting his or her autonomy and quality of life.

Impairments in cognitive function can be dynamic, changing in an individual over time. An early brain injury in a child, for example, can disrupt learning and development as the child gets older, presenting new cognitive and behavioral problems at each development milestone, i.e., ages 1-6, 7-10, 11-23, 14-17, and 18-21. In adults with brain injuries, problems associated with arousal, attention, and memory-encoding may be most prevalent at early stages in recovery, while difficulties with divided attention, memory retrieval, and executive functions may predominate at later stages in recovery.

Cognitive training protocols are generally employed in rehabilitating individuals who have some form and degree of cognitive dysfunction. Training protocols have been used, for example, to treat elderly patients suffering from age-related memory loss or to treat post-stroke patients in rehabilitation centers.

Current therapy based on training protocols, however, is limited by a number of factors. First, traditional rehabilitation centers typically focus on only a subset of cognitive impairments. Second, therapy can be very costly and time-consuming because it typically requires multiple training sessions, which can span many hours and many weeks, to achieve an improvement or enhancement of a specific aspect of cognitive performance (ability or function). Third, therapy is often based on suboptimal protocols unable to induce generalized benefits that endure over time. Finally, therapy often lacks the patient information necessary to provide customized treatments that are able to adapt to a patient's changing needs over time.

In addition, cognitive impairments can also be accompanied by motor deficits, further complicating the rehabilitation process. Both deficits, for example, often occur after traumatic brain injury (TBI). And as in cognitive impairment, the standard of care for motor deficits is usually intensive and extensive rehabilitation.

Hence there is a need for systems and methods that offer greater accessibility, specificity, and efficacy of cognitive and motor rehabilitation and therefore improve functional outcome. The present invention addresses these and other needs in the art.

### SUMMARY OF THE INVENTION

Systems and methods for treating patients to improve cognitive abilities are disclosed. One exemplary method comprises receiving a visiting patient at a clinic, administering an augmenting agent to the visiting patient, training the visiting patient to stimulate neuronal activity, and recording augmenting agent administration data and patient training data associated with the visiting patient. The administering and training steps may occur at the clinic or remotely. The augmenting agent may comprise a phosphodiesterase 4 (PDE 4) inhibitor. The method may further comprise receiving a returning patient at the clinic, administering the augmenting agent to the returning patient, training the returning patient to stimulate neuronal activity, and recording augmenting agent administration data and patient training data associated with the returning patient.

The method may further comprise analyzing a condition of the visiting patient. Analyzing the condition of the visiting patient may comprise diagnosing the visiting patient and/or reviewing a diagnosis of the visiting patient.

Further, recording the augmenting agent administration and the visiting patient training of the visiting patient may comprise providing a record of the augmenting agent administration and the visiting patient training associated with the visiting patient to a user at a remote location. The record may be provided to the user at the remote location over a network.

The method may also comprise testing the patient. In some embodiments, an amount of augmenting agent that is administered to the visiting patient may be dependent (at least in part) upon the testing. Further, the duration of the training of the visiting patient may be dependent (at least in part) upon the testing. The result of testing the visiting patient may also be compared against a predetermined threshold. In various embodiments, the visiting patient may be notified that returning to the clinic is not necessary based on the comparison.

Training the visiting patient may comprise cognitive training. Further, the visiting patient may suffer from cognitive dysfunction, impairing one or more cognitive processes, including attention, learning, memory, language, speech, motor activities, and executive functions.

In some embodiments, a computer readable medium comprises executable instructions. The instructions can include those for profiling a patient's cognitive abilities or for providing cognitive training protocols. The executable instructions may be executable by a processor to perform a method. The method may comprise receiving patient data of a visiting patient, receiving augmenting agent administration data of the visiting patient, receiving training data associated with training the visiting patient to stimulate neuronal activity, analyzing the augmenting agent administration data and the training data associated with the visiting patient over time, and displaying the analysis of the augmenting agent administration data and the training data associated with the visiting patient to a first user.

An exemplary system may comprise a means for enhancing a cyclic AMP response element binding protein (CREB) pathway of a visiting patient, a treatment device, and a display. The treatment device may comprise a patient data module, an augmenting agent administration module, a training module, and an analysis module. The patient data module may be configured to receive patient data of the visiting patient. The augmenting agent administration module may be configured to receive augmenting agent administration data associated with the means for enhancing the CREB pathway of the visiting patient. The training module may be configured to receive training data. The analysis module may be configured to analyze the augmenting agent administration data and the training data associated with the visiting patient over time. The display may be configured to display the analysis of the augmenting agent administration data and the training data associated with the visiting patient to a first user.

Also disclosed are systems and methods for treating patients to improve motor function are disclosed. One exemplary method comprises receiving a visiting patient at a clinic, administering an augmenting agent to the visiting patient, training the visiting patient to stimulate neuronal activity, and recording augmenting agent administration data and patient training data associated with the visiting patient.

The administering and training steps may occur at the clinic or remotely, and the augmenting agent may comprise a phosphodiesterase 4 (PDE 4) inhibitor. The method may further comprise receiving a returning patient at the clinic, administering the augmenting agent to the returning patient, training the returning patient to stimulate neuronal activity, and recording augmenting agent administration data and patient training data associated with the returning patient. Further, the visiting patient may suffer from brain trauma, resulting in one or more motor deficits.

Another embodiment relates to a digital device aided therapy to improve a nervous system function in a patient, comprising providing a digital device with access to a database including information on the patient and a training threshold inputting a training procedure customized for the patient using the digital device, providing training procedure access using the digital device to the patient or a person overseeing the patient during the training procedure, recording the patient's execution of the training procedure, determining the training score from the patient's execution of the training procedure using the digital device, comparing the training score to the training threshold using the digital device, and repeating the steps if the digital device determines that the training score is less than the training threshold.

Another embodiment relates to a treatment system for improving a nervous system function in a patient, comprising a database capable of storing data including patient data, augmenting agent data, training data and analyzed data and a digital device including: (i) an input interface to enter data, (ii) a display interface to display data, (iii) a patient data module configured to receive patient data, (iv) an augmenting agent administration module configured to receive augmenting agent data, (v) a training module configured to receive training data, (vi) a communication module configured to provide communication between the digital device and the database and (vii) an analysis module configured to perform analysis of the data and provide analyzed data.

### BRIEF DESCRIPTION OF THE DRAWINGS

FIG. 6 is an exemplary environment of a clinic capable of treating patients of cognitive disorders.

FIG. 7 is a block diagram of an exemplary system for communicating data associated with treatment of patients.

FIG. 8 is a block diagram of an exemplary treatment device.

FIG. 9 is a flow chart of an exemplary method of treating patients.

FIG. 10 is a block diagram of an exemplary digital device.

### DETAILED DESCRIPTION

### Definitions

The following defined terms are used throughout the present specification, and should be helpful in understanding the scope and practice of the present invention.

As used herein and in the appended claims, the singular forms “a,” “an,” and “the” include the plural references unless the context clearly dictates otherwise. Thus, for example, a reference to “a training protocol” is a reference to one or more training protocols and included equivalents thereof known to those skilled in the art and so forth.

The term “about” or “approximately” means within an acceptable range for the particular value as determined by one of ordinary skill in the art, which will depend in part on how the value is measured or determined, e.g., the limitations of the measurement system. For example, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As used herein, the term “disorder” is used interchangeably with “disease” or “condition”. For example, a CNS disorder also means a CNS disease or a CNS condition.

As used herein, the term “cognitive impairment” is used interchangeably with “cognitive dysfunction” or “cognitive deficit,” all of which are deemed to cover the same therapeutic indications.

The terms “treating,” “treatment,” and “treat” cover therapeutic methods directed to a disease-state in a subject and include: (i) preventing the disease-state from occurring, in particular, when the subject is predisposed to the disease-state but has not yet been diagnosed as having it; (ii) inhibiting the disease-state, e.g., arresting its development (progression) or delaying its onset; and (iii) relieving the disease-state, e.g., causing regression of the disease state until a desired endpoint is reached. Treating also includes ameliorating a symptom of a disease (e.g., reducing the pain, discomfort, or deficit), wherein such amelioration may be directly affecting the disease (e.g., affecting the disease's cause, transmission, or expression) or not directly affecting the disease.

As used in the present disclosure, the term “effective amount” is interchangeable with “therapeutically effective amount” and means an amount or dose of a compound or composition effective in treating the particular disease, condition, or disorder disclosed herein and thus producing the desired preventative, inhibitory, relieving, or ameliorative effect. In methods of treatment according to the invention, “an effective amount” of at least one compound according to the invention is administered to a subject (e.g., a mammal). An “effective amount” also means an amount or dose of a compound or composition effective to modulate activity of MAO-B or an associated signaling pathway, such as the CREB pathway and thus produce the desired modulatory effect. The “effective amount” will vary, depending on the compound, the disease and its severity, and age, weight, etc.

The term “animal” is interchangeable with “subject” and may be a vertebrate, in particular, a mammal, and more particularly, a human, and includes a laboratory animal in the context of a clinical trial or screening or activity experiment. Thus, as can be readily understood by one of ordinary skill in the art, the compositions and methods of the present invention are particularly suited to administration to any vertebrate, particularly a mammal, and more particularly, a human.

As used herein, a “control animal” or a “normal animal” is an animal that is of the same species as, and otherwise comparable to (e.g., similar age, sex), the animal that is trained under conditions sufficient to induce transcription-dependent memory formation in that animal.

By “enhance,” “enhancing” or “enhancement” is meant the ability to potentiate, increase, improve or make greater or better, relative to normal, a biochemical or physiological action or effect. For example, enhancing long term memory formation refers to the ability to potentiate or increase long term memory formation in an animal relative to the normal long term memory formation of the animal. As a result, long term memory acquisition is faster or better retained. Enhancing performance of a cognitive task refers to the ability to potentiate or improve performance of a specified cognitive task by an animal relative to the normal performance of the cognitive task by the animal.

As used herein, the term “training protocol,” or “training,” refers to either “cognitive training” or “motor training.” The phrase “in conjunction” means that a compound or composition of the present invention enhances CREB pathway function during cognitive or motor training.

Reference will now be made to the embodiments of the present invention, examples of which are illustrated by and described in conjunction with the accompanying drawings and examples. While certain embodiments are described herein, it is understood that the described embodiments are not intended to limit the scope of the invention. On the contrary, the present disclosure is intended to cover alternatives, modifications, and equivalents that can be included within the invention as defined by the appended claims.

### Molecular Biology

In accordance with the present invention, there may be employed conventional molecular biology, microbiology, recombinant DNA, immunology, cell biology and other related techniques within the skill of the art. See, e.g., Sambrook et al. (2001) Molecular Cloning: A Laboratory Manual. 3rd ed. Cold Spring Harbor Laboratory Press: Cold Spring Harbor, New York; Sambrook et al. (1989) Molecular Cloning: A Laboratory Manual. 2nd ed. Cold Spring Harbor Laboratory Press: Cold Spring Harbor, New York; Ausubel et al. eds. (2005) Current Protocols in Molecular Biology. John Wiley and Sons, Inc.: Hoboken, N.J.; Bonifacino et al. eds. (2005) Current Protocols in Cell Biology. John Wiley and Sons, Inc.: Hoboken, N.J.; Coligan et al. eds. (2005) Current Protocols in Immunology, John Wiley and Sons, Inc.: Hoboken, N.J.; Coico et al. eds. (2005) Current Protocols in Microbiology, John Wiley and Sons, Inc.: Hoboken, N.J.; Coligan et al. eds. (2005) Current Protocols in Protein Science, John Wiley and Sons, Inc.: Hoboken, N.J.; Enna et al. eds. (2005) Current Protocols in Pharmacology John Wiley and Sons, Inc.: Hoboken, N.J.; Hames et al. eds. (1999) Protein Expression: A Practical Approach. Oxford University Press: Oxford; Freshney (2000) Culture of Animal Cells: A Manual of Basic Technique. 4th ed. Wiley-Liss; among others. The Protocols above are routinely updated.

### Treatment Programs

The present invention provides systems, methods and therapies directed to clinics providing treatment programs to improve nervous system function, for example a cognitive or motor ability in a patient. In one aspect, treatment programs to improve a cognitive ability include rehabilitating various forms of cognitive dysfunction or enhancing normal cognitive performance (ability or function). In another aspect, treatment programs to improve a motor ability include rehabilitating various forms of motor dysfunction or enhancing normal motor performance (ability or function).

In various embodiments, treatment programs of the instant invention comprise enhancing a specific aspect of performance in a patient by administering an augmenting agent which enhances CREB pathway function; and, optionally (b) providing a protocol to stimulate neural activity. In a preferred embodiment, the invention provides treatment programs based on Augmented Cognitive Training (ACT) to combine particular drug therapy with specific brain exercises—which is disclosed herein.

In a preferred embodiment, the invention provides treatment programs based on Augmented Cognitive Training (ACT) to combine particular drug therapy with specific brain exercises—which is disclosed herein. This notion of combination therapy is important because a greater specificity of drug action can be conveyed to the brain via activation of specific circuitries underlying a particular cognitive function. See, e.g., MacDonald et al. 2007, A novel phosphodiesterase type 4 inhibitor, HT-0712, enhances rehabilitation-dependent motor recovery and cortical reorganization after focal cortical ischemia, Neurorehabil. Neural Repair 21, 486-496.

### Program Components

In preferred embodiments, the present invention provides components needed for a clinic to assess a patient's needs and to implement a program directed to a cognitive function.

### Assessment

Neuropsychological assessment has been developed by cognitive psychologists for more than 50 years (Lezak et al. 2004, Neuropsychological Assessment, 4th Edition (New York, Oxford University Press)). Many tests exist to quantify performance in various functionally distinctive cognitive domains, such as orientation and attention; visual, auditory, or tactile perception; verbal, visual, or tactile memory; remote memory, paired memory; verbal skills; and executive functions. Many have now been adapted to computer-based cognitive testing (Crook et al. 2008, Computer-based cognitive testing, In Methods of Comprehensive Neuropsychological Assessment). In each case, individual performance is evaluated against data to determine extreme (high or low) scores.

In general, a test comprises a set of distinct exercises that can be process-specific or skill-based. Responses to the exercises may be used to determine a score.

Accordingly, the present invention includes a battery of cognitive tests, which comprise a diagnostic kit to diagnose, identify and treat various aspects of cognitive dysfunction brought about by heredity, disease, injury, or age.

### Clinics

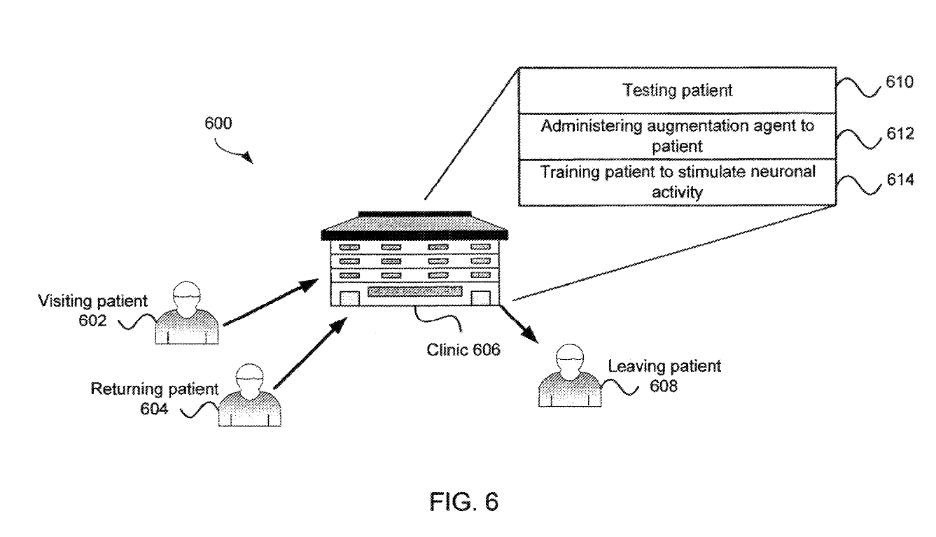

FIG. 6 is an exemplary environment 600 of a clinic 606 capable of treating patients 602, 604, and 608 which may have cognitive disorders and/or wish to improve cognitive ability. The environment 600 comprises visiting patient 602, returning patient 604, clinic 606, and leaving patient 608. The clinic 606 may perform functions including function 610, testing a patient, function 612, administration of augmenting agent to a patient, and function 614, training patient to stimulate neuronal activity. Even though functions 610, 612, and 614 are identified by ordered numbers, these functions may occur at any time and in any order.

In various embodiments, visiting patient 602 and returning patient 604 may be any person wishing to: (1) rehabilitate various forms of cognitive dysfunction more efficiently than any current method, (2) enhance normal cognitive performance (ability or function), (3) rehabilitate various forms of motor dysfunction more efficiently than any current method, or (4) enhance normal motor performance (ability or function). In one example, the visiting patient 602 is a person who is seeking treatment for the first time. The visiting patient 602 may have been previously injured and may be seeking treatment for rehabilitation.

The returning patient 604 is any person which returns for ongoing treatment (e.g., to receive the augmenting agent and undergo training). The leaving patient 608 may return as a returning patient 604 for another treatment and/or appointment.

The clinic 606 is any facility or building where patients (e.g., visiting patient 602 and returning patient 604) may seek treatment to improve cognitive ability. In some embodiments, the clinic 606 is a hospital or other medical facility. Those skilled in the art will appreciate that the clinic 606 may be any place where the patient may receive treatment.

The treatment of the clinic 606 may comprise function 610, testing a patient (e.g., visiting patient 602 or returning patient 604), function 612, administering the augmenting agent to the patient, and function 614, training the patient to stimulate neuronal activity.

As discussed herein, treatment may cure, treat, and/or provide sustained improvement for illness such as cognitive deficit (e.g., associated with age-associated memory impairment, neurodegenerative disease, psychiatric disease, trauma dependent loss of cognitive function, or genetic defect), motor deficit, impairment to cognitive performance, and/or impairment to cognitive function. In some embodiments, each patient is tested (function 610). In one example, overall cognitive ability is tested. Testing may also be performed that is directed towards a specific illness such as cognitive deficit or motor deficit of the patient. Testing may determine whether treatment may be helpful, the type of treatment to be provided (e.g., the type of augmenting agent), the dosage of the augmenting agent, the type of training, the duration of training, as well as the length and type of ongoing treatment.

In some embodiments, cognitive training occurs before or after administration of the augmenting agent. In some embodiments, cognitive training may occur even if the augmenting agent is not and will not be administered to the patient. Those skilled in the art will appreciate that the patient's condition and testing may determine the protocol of instant and ongoing treatment as well as recurring appointments for treatment.

Those skilled in the art will appreciate that the clinic 606 may not only be adapted to treat patients of cognitive disorders but may also be adapted to treat any patient for any disorder or illness. Further, the clinic 606 may be adapted to treat patients without any disorder or illness but wish to enhance or improve cognitive ability.

### Devices and Modules

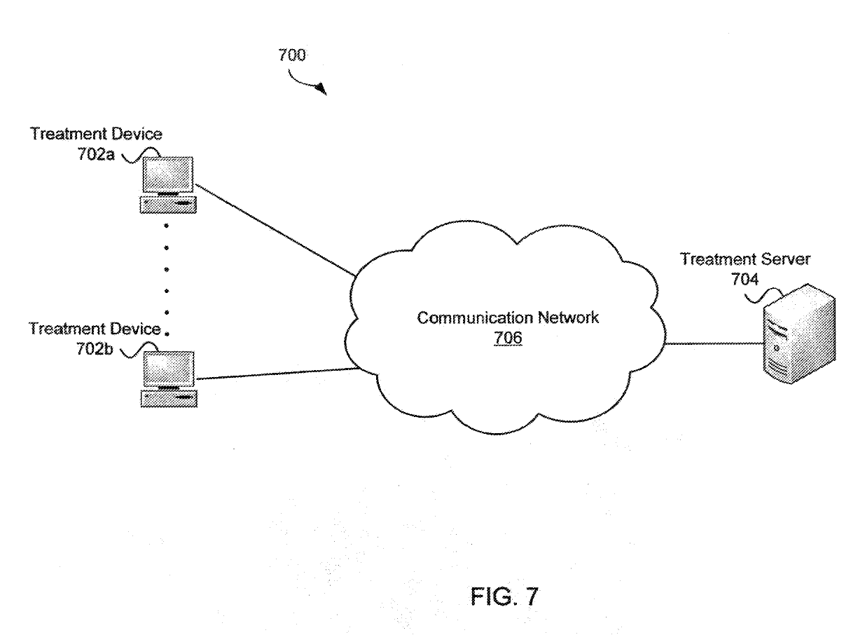

FIG. 7 is a block diagram of an exemplary system 700 for communicating data associated with treatment of patients in, for example, the exemplary environment 600 of the clinic 606. The system 700 comprises treatment devices 702a-702b and a treatment server 704 coupled to a communication network 706. The treatment devices 702a-702b and treatment server 704 may be digital devices. A digital device is any device with at least one processor and memory or any device capable of communication with a device with at least one processor and memory. In some examples, a digital device may be a computer such as a desktop computer or laptop, smartphone, or media tablet. Digital devices are discussed further herein.

Treatment devices 702a-702b are any digital device configured to receive information associated with treatment of a patient and provide at least some data associated with the information to the treatment server 704. For simplicity, one treatment device 702 will be discussed. Those skilled in the art will appreciate that there may be any number of treatment devices performing similar functions associated with treatment for one or more patients.

The treatment device 702 may be configured to receive (e.g., input) treatment information. The treatment information may comprise patient data, augmenting agent administration data (including augmenting agent protocols), and training data (including training protocols). Patient data may comprise, for example, the patient's name, medical information, or diagnosis. Augmenting agent administration data may comprise when an augmenting agent was administered to a patient, the dosage, as well as the composition of the augmenting agent. The training data may comprise the type of training performed on a patient, any notes taken during training, training results, and duration of training.

In some embodiments, the treatment device 702 may be used to perform at least some training and/or testing of the patient. In various embodiments, the treatment device 702 may be used to test the memory or reflexes of the patient by showing the patient images, testing the patient's recall of the images, and/or requiring the patient to interact with an input device (e.g., keyboard, mouse, joystick, or button) of the treatment device 702. The treatment device 702 may also be used to provide sounds that may be used during training or testing. The treatment device 702 may also be used for games and/or simulations that may be used to help train and/or test the patient.

The treatment server 704 may be configured to provide some or all of the treatment information to the treatment server 704. In various embodiments, the treatment device 702 is a dumb terminal which displays information retrieved from the treatment server 704.

The treatment server 704 is a digital device that is configured to receive at least some treatment information from the treatment device 702. In various embodiments, the treatment server 704 may receive treatment information from any number of treatment devices. The collected information may then be analyzed to improve treatment such as recommended dosage of augmenting agent, treatment plans (e.g., recurrence of dosage of augmenting agent), type of training, length of training and such. Based on the analysis, the treatment server 704 may provide recommendations or orders of treatment for one or more patients or groups of patients.

In some embodiments, based on the treatment information, a user of the treatment server 704 may diagnose the patient from a remote location. The user may then provide treatment instructions to the clinic or treatment personnel (e.g., technicians, doctors, nurses, or any person or digital device which can provide training and or administer the augmenting agent to the patient) through the treatment device 702. Treatment instructions may comprise instructions associated with an augmenting agent protocol (e.g., the administration of the augmenting agent, type of augmenting agent, amount of augmenting agent, composition of the augmenting agent), a training protocol (e.g., type of training, duration of training), testing of the patient, or analysis of a condition of a patient. In some embodiments, some or all of the treatment instructions may be provided to the treatment device 702 from the treatment server 704. The treatment server 704 may also provide games, simulations, images, and/or sounds, for example, to the treatment device 702 for training and/or testing of the user.

Although only one treatment server 704 is displayed, those skilled in the art will appreciate that there may be any number of treatment server 704. In various embodiments, communication between the treatment device 702 and the treatment server 704 may be encrypted.

The communication network 706 may be any network including but not limited to, a local area network (LAN) or wide area network (WAN). In some embodiments, the treatment device 702 and the treatment server 704 are part of a private network (e.g., a private network of a clinic). In other embodiments, the treatment device 702 and the treatment server 704 are a part of a public network such as the Internet. The communication network 706 may comprise any number of networks.

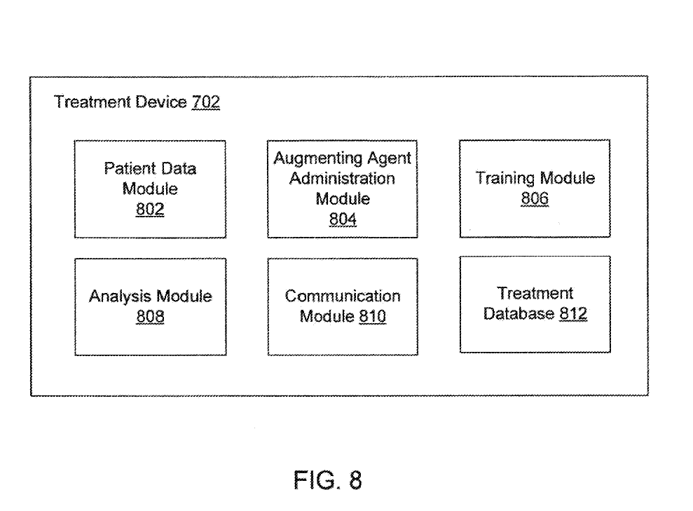

FIG. 8 is a block diagram of an exemplary treatment device 702. The treatment device 702 may comprise a patient data module 802, augmenting agent administration module 804, training module 806, analysis module 808, communication module 810, and a treatment database 812. A module is any software, hardware, or combination of both hardware and software configured to either perform or assist in the performing of functions. In various embodiments, the treatment device 702 displays an interface to a user. The user may then input and/or display patient data, augmenting agent administration data, and patient training data in to the treatment device 702.

In various embodiments, the patient data module 802 is configured to receive and/or display the patient data and update any patient records within the treatment database 812. The patient data module 802 may also provide information to confirm and/or authenticate the patient, the patient data, and/or the user of the treatment device 702.

The augmenting agent administration module 804 may be configured to receive and/or display augmenting agent administration data. The augmenting agent administration data may comprise data associated with the augmenting agent (e.g., composition) and/or administration of the augmenting agent (e.g., dosage). The augmenting information may also include past treatments which included treatment with the augmenting agent.

The training module 806 may be configured to receive and/or display information about the training of the patient including the type of training and duration of the training. The training module 806 may also receive information about a patient's past training and/or past activities. The training module 806 may also record the patient's execution of and responses to a training program, protocol or procedure.

The analysis module 808 may be configured to analyze and/or display a patient's condition and/or testing. In some embodiments, the analysis module 808 receives information regarding a patient's condition or testing. In one example, the analysis module 808 may receive or make a diagnosis regarding the patient. The analysis module 808 may be configured to provide advice or instructions regarding treatment of the patient (e.g., administration of the augmenting agent and/or training) based on a diagnosis. In another example, the analysis module 808 may analyze a patient's training and provide advice or instructions regarding treatment of the patient.

In some embodiments, the analysis module 808 may provide the analysis or results of analysis to the treatment server 704. The treatment server 704 may confirm the analysis or results of analysis. The treatment server 704 may also make recommendations or instructions to the treatment device 702 or the user of the treatment device 702 regarding treatment of the patient based on the analysis. In other embodiments, the treatment server 704 performs the analysis.

The communication module 810 may be configured to communicate with the treatment server 704. In various embodiments, the communication module 810 provides the augmenting agent administration data, the patient training data, the patient data, and/or analysis to the treatment device 704. The communication module 810 may also receive patient data (e.g., past medical history, diagnosis, or evaluation) from the treatment device 704.

The treatment database 812 is any data structure configured to store patient data. The treatment database 812 may also be configured to store the augmenting agent administration data, the patient training data, and/or analysis. Those skilled in the art will appreciate that the treatment device 812 is optional and that the patient data, the augmenting agent administration data, the patient training data, and/or analysis may be stored at a second database, for example the treatment server 706.

In some embodiments, the treatment device 702 is further configured to monitor a patient. In one example, the treatment device 702 monitors vital signs and/or signals associated with cognitive training during administration of the augmenting agent, training, and/or testing.

Those skilled in the art will appreciate that there may be any number of modules. In some embodiments, the functions of one or more modules may be combined.

### Methods

The overall goal of treatment can include restoring function in a cognitive domain or set of domains, teaching compensatory strategies to overcome domain specific problems, improving performance of a specific activity, or generalizing a performance gain to multiple activities.

Some treatments may involve reestablishing previous skills and behavior patterns, while others may involve establishing new skills or enabling adaptation to adjust to problems that are not modifiable.

Some rehabilitation treatments are directly applied using actual functional activities in real-world settings while others improve a specific process or an activity in a clinical setting that is intended to generalize to actual performance in real-life situations.

By providing convenient access and customized training programs, particularly programs based on ACT, systems and methods of the instant invention can produce gains in cognitive performance quickly and efficiently. Therapies based on ACT, for example, can decrease the time require to attain a significant gain in performance, compared with training alone. In one aspect, this decrease can reflect a reduction in the number of training sessions. In another aspect, this decrease can reflect a reduction in time between training sessions.

An exemplary treatment program includes administering an augmenting agent in conjunction with a training protocol to the patient (e.g., Augmented Cognitive Training (ACT) further discussed herein). Treatments based on the training protocols may be process-specific, focused on improving a particular cognitive domain such as attention, memory, language, or executive functions. Alternatively, treatments may be skill-based, aimed at improving performance of particular activities.

In one example, a patient makes multiple appointments to receive the augmenting agent and cognitive training. During an initial appointment, the patient's condition may be analyzed (e.g., diagnosed) and a treatment program determined. The patient may receive the augmenting agent and cognitive training during the initial appointment as well as subsequent appointments. The patient may be tested to help determine the effectiveness of the treatment (e.g., the administration of the augmenting agent and the cognitive training program). The amount of augmenting agent administered, the composition of the augmenting agent, the duration of cognitive training, and the type of cognitive training may be based upon testing and retesting of the patient over subsequent appointments.

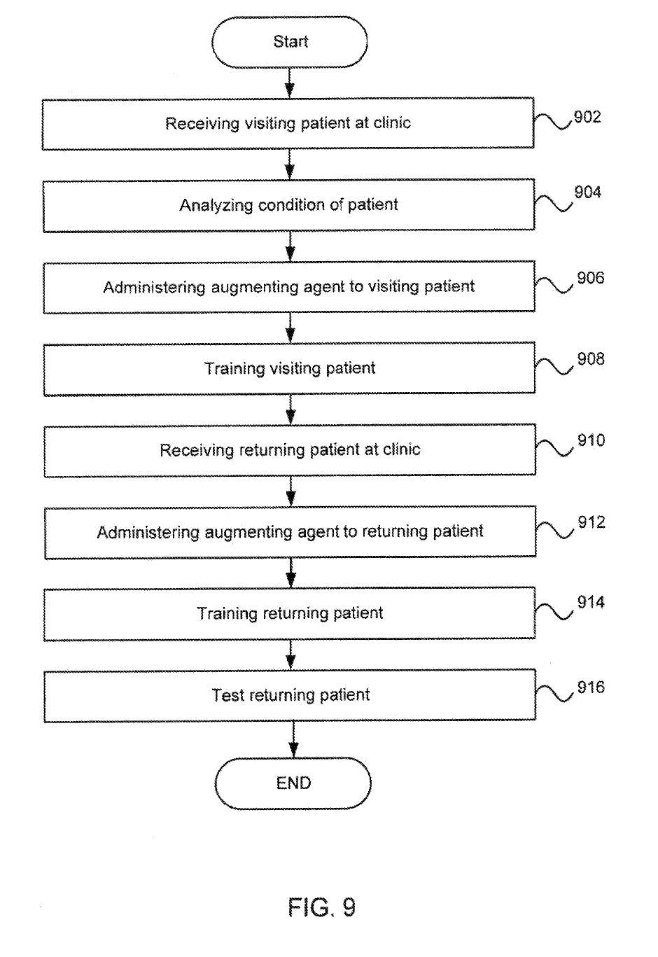

FIG. 9 is a flow chart of an exemplary method for treating patients. In step 902, a visiting patient 602 is received by a clinic 606. The visiting patient 602 may suffer from a cognitive dysfunction or simply wish to improve their cognitive ability.

In step 904, an analysis is performed on the condition of the patient. In one example, trained personnel (e.g., doctors, nurses, or technicians) may review the visiting patient's condition, past medical history, accidents involving the visiting patient 602, cognitive dysfunction(s), past treatments, and medications currently being taken by the visiting patient 602. In some embodiments, a diagnosis is performed based on the condition of the patient. In some embodiments, the analysis module 808 may perform all or some of the diagnosis.

The visiting patient may also be tested to further evaluate the patient's condition. For example, the visiting patient's cognitive ability may be tested to evaluate cognitive dysfunction and/or to record results which may be the basis of comparison for other tests after treatment has commenced. In some embodiments, the results of testing may be compared against a predetermined threshold. In some examples, the threshold may represent a level of improvement or a level of disability. The threshold may be determined or revised based on the patient's past training, testing and/or expectations based on the patient's condition and others who share the condition of the patient. In some embodiments, the treatment server 704 determines one or more thresholds based on the data the treatment server 704 receives from treatment devices and data associated with a plurality of users. If the results of testing, when compared to a threshold, show sufficient improvement, further treatment may be terminated.

In step 906, an augmenting agent is administered to the visiting patient 602. The dosage and type of augmenting agent may be based on previous treatments, the patient's condition, previous testing of the patient, amount of augmenting agent previously administered, the dosage of the augmenting agent previously administered and/or cognitive training which has been or will be performed by the visiting patient 602.

In step 908, the visiting patient 602 is trained. Training may comprise cognitive training as discussed herein. The type and duration of cognitive training may be based on previous treatments, the patient's condition, previous testing of the patient, amount of augmenting agent previously administered, the dosage of the augmenting agent previously administered, and/or cognitive training which has been performed by the visiting patient 602.

In step 910, a returning patient 604 may return to the clinic. In some embodiments, after the visiting patient is received by the clinic and the condition of the visiting patient is analyzed, the visiting patient may receive the augmenting agent and training. After the administration of the augmenting agent and training, the patient may be put on a treatment program whereby the visiting patient 602 returns to the clinic as returning patient 604 for additional treatment(s). The number of treatments, the type and dosage of augmenting agent to be administered in latter appointments, and/or the type and duration of the training may be planned based on the condition and testing of the patient.

In step 912, the augmenting agent is administered to the returning patient 604. In some embodiments the type and dosage of the augmenting agent is similar to the type and dosage of the augmenting agent administered to the patient in their previous visit. In step 914, the returning patient is trained. In some embodiments the type and duration of training is similar to the type and duration training of the patient in their previous visit.

In step 916, the returning patient is tested to determine treatment effectiveness, cognitive ability, and/or cognitive dysfunction. In various embodiments, future appointments involving the administration of the augmenting agent (e.g., dosage and type) and training (e.g., type and duration) may be based on testing and comparing the results of the test to past testing, predetermined thresholds, and/or results of tests performed by other patients under similar circumstances (e.g., patients sharing a similar cognitive dysfunction at a shared point in treatment).

Those skilled in the art will appreciate that the steps of FIG. 9 may be performed in any order. In one example, the patient is tested before the augmenting agent is administered and/or training is performed. The treatment and future treatments may depend upon testing. The results of the testing as well as information regarding any of the steps may be stored and/or provided to the treatment server 704. In some embodiments, the treatment server 704 is remote from the treatment device 702. A user of the treatment server 704 may review the testing results and treatment information.

### System Hardware

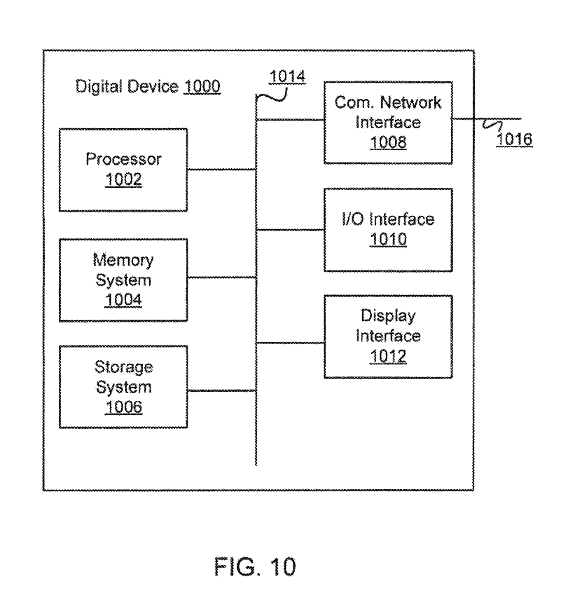

FIG. 10 is a block diagram of an exemplary digital device 1000. The digital device 1000 comprises a processor 1002, a memory system 1004, a storage system 1006, a communication network interface 1008, an I/O interface 1010, and a display interface 1012 communicatively coupled to a bus 1014. The processor 1002 is configured to execute executable instructions (e.g., programs). In some embodiments, the processor 1002 comprises circuitry or any processor capable of processing the executable instructions.

The memory system 1004 is any memory configured to store data. Some examples of the memory system 1004 are storage devices, such as RAM or ROM. The memory system 1004 can comprise the ram cache. In various embodiments, data is stored within the memory system 1004. The data within the memory system 1004 may be cleared or ultimately transferred to the storage system 1006.

The storage system 1006 is any storage configured to retrieve and store data. Some examples of the storage system 1006 are flash drives, hard drives, optical drives, and/or magnetic tape. In some embodiments, the digital device 1000 includes a memory system 1004 in the form of RAM and a storage system 1006 in the form of flash data. Both the memory system 1004 and the storage system 1006 comprise computer readable media which may store instructions or programs that are executable by a computer processor including the processor 1002.

The communication network interface (com. network interface) 1008 can be coupled to a network (e.g., communication network 706) via the link 1016. The communication network interface 1008 may support communication over an Ethernet connection, a serial connection, a parallel connection, or an ATA connection, for example. The communication network interface 1008 may also support wireless communication (e.g., 802.11 a/b/g/n, WiMax). It will be apparent to those skilled in the art that the communication network interface 1008 can support many wired and wireless standards.

The optional input/output (I/O) interface 1010 is any device that receives input from the user and output data. The optional display interface 1012 is any device that is configured to output graphics and data to a display device (e.g., monitor, display, or television). In one example, the display interface 1012 is a graphics adapter.

It will be appreciated by those skilled in the art that the hardware elements of the digital device 1000 are not limited to those depicted in FIG. 10. A digital device 1000 may comprise more or less hardware elements than those depicted. Further, hardware elements may share functionality and still be within various embodiments described herein. In one example, encoding and/or decoding may be performed by the processor 1002 and/or a co-processor located on or in conjunction with a GPU (i.e., Nvidia).

Cognitive dysfunction, commonly associated with brain dysfunction and central nervous system (CNS) disorders or conditions, arises due to heredity, disease, injury and/or age. CNS disorders and conditions associated with some form and degree of cognitive failure (dysfunction) include, but are not limited to the following:

### Patients

The systems and methods of the present invention are applicable to a broad spectrum of patients, particularly those wishing to improve cognitive or motor function. Some patients may have severe or mild impairments in cognitive or motor functions. Accordingly, a patient may exhibit impairments in one or more cognitive processes, such as attention, learning, memory, language, speech, and executive functions, e.g., planning, organizing, sequencing, and abstracting. Still other patients may have no significant impairments but desire to improve the efficiency with which they can achieve a gain in cognitive or motor function.

Patients with cognitive or motor dysfunction may have one or more neurological disorders and conditions, which including the following categories:

Age-Associated Memory Impairments:

This category includes, but is not limited to, patients in early stages of cognitive decline, including patients diagnosed with Age-Associated Cognitive Deficits (AAMI) and Mild Cognitive Impairment (MCI).

In a specific embodiment, the invention provides a method of treating an age-associated cognitive deficit. In one aspect, the age-associated cognitive deficit is AAMI. Accordingly, the invention provides a method of treating AAMI, comprising administering to an animal in need of such treatment an effective amount of a compound or composition of the present invention.

AAMI is a decline in various cognitive abilities, in particular memory abilities, associated with normal aging. For example, AAMI subjects show a decline in the ability to encode new memories of events or facts, as well as working memory. See, e.g., Hedden and Gabrieli, 2004, Insights into the aging mind—a view from cognitive neuroscience, Nat. Rev. Neurosci. 5, 87-96. In addition, AAMI subjects, when compared with age-matched controls, appeared to be impaired in tests of executive functions associated with frontal lobe function. These and other studies suggest an important role for frontal lobe dysfunction in the memory loss of elderly people. More generally, studies comparing the effects of aging on episodic memory, semantic memory, short-term memory and priming find that episodic memory is especially impaired in normal aging; but some types of short-term memory can also be impaired. Nilsson, 2003, Memory function in normal aging, Acta Neurol. Scand. Suppl. 179, 7-13.

In general, an AAMI diagnosis identifies persons with subjectively and objectively evidenced memory loss without cognitive decline impaired enough to warrant the diagnosis of dementia. According to criteria established by the NIH working group (Crook et al., 1986, Age-associated memory impairment: proposed diagnostic criteria and measures of clinical damage—report of a National Institute of Mental Health work group, Devel. Neuropsychol. 2, 261-276) a diagnosis of AAMI includes the following in a person aged 50 or older:
(1) the presence of subjective memory decline, e.g., complaints of memory loss reflected in such everyday problems as difficulty remembering names of individuals introduced to the subject, misplacing objects, difficulty remembering a list of items to be purchased or a list of tasks to be performed;
(2) objective evidence of memory loss (e.g., a score at least one standard deviation below the mean of younger adults in a well standardized memory test);
(3) evidence of adequate intellectual function (e.g., a raw score of at least 32) on the Vocabulary subtest of the Wechsler Adult Intelligence Scale.; and
(4) the absence of dementia (or other memory-affecting disease, such as stroke), e.g., based on the Global Deterioration Scale for assessment of dementia, individuals with AAMI have very mild cognitive decline (level 2). Reisberg et al., 1982, The global deterioration Scale for assessment of primary degenerative dementia, Am. J. Psych. 139, 1136-1139.

Individuals with AAMI have been shown to have a three-fold greater risk for development of dementia than individuals who do not meet AAMI criteria Goldman and Morris, 2002, Evidence that age-associated memory impairment is not a normal variant of aging. Alzheimer Dis. Assoc. Disord. 15:72-79.

In a specific embodiment, the invention provides a method of treating MCI, comprising administering to an animal in need of such treatment an effective amount of a compound or composition of the present invention.

MCI may be diagnosed when an individual's memory declines below the level considered normal for that age group. In other words, MCI is a condition in which people face memory problems more often than that of the average person their age. These symptoms, however, do not prevent them from carrying out normal activities and are not as severe as the symptoms for Alzheimer's disease. Symptoms often include misplacing items, forgetting events or appointments, and having trouble thinking of desired words.

According to recent research, MCI has been called the transitional state between cognitive changes of normal aging and Alzheimer's disease (AD). Many people who experience mild cognitive impairment are at a high risk of developing Alzheimer's disease. Indeed, research suggests that: about 12% of people aged 65 or older diagnosed with MCI go on to develop Alzheimer's disease within a year; and that about 40% develop Alzheimer's within three years. This is a much higher rate than in the general population, wherein only about 1% of people aged 65 or older develop Alzheimer's each year.

Thus, people with MCI are considered at heightened risk to develop Alzheimer's disease. These symptoms, however, do not prevent them from carrying out normal activities and are not as severe as the symptoms for Alzheimer's disease. Symptoms often include misplacing items, forgetting events or appointments, and having trouble thinking of desired words. See, e.g., Arnáiz and Almkvist, 2003, Neuropsychological features of mild cognitive impairment and preclinical Alzheimer's disease. Acta Neurol. Scand. Suppl. 179, 34-41. Some patients with MCI, however, never progress to AD.

Neurodegenerative Diseases:

In particular embodiments, the invention provides a method of treating a neurodegenerative disorder, comprising administering to an animal in need of such treatment an effective amount of a compound or composition of the present invention. This category includes, but is not limited to, delirium (acute confusional state); Alzheimer's disease including Alzheimer's type dementia; and non-Alzheimer's type dementias, such as, but not limited to, Lewy body dementia, vascular dementia, Binswanger's dementia (subcortical arteriosclerotic encephalopathy), dementias associated with Parkinson's disease, progressive supranuclear palsy, Huntington's disease (chorea), Pick's disease, normal-pressure hydrocephalus, Creutzfeldt-Jakob disease, Gerstmann-Strussler-Scheinker disease, neurosyphilis (general paresis) or HIV infection, frontal lobe dementia syndromes, Amyotrophic lateral sclerosis, corticobasal degeneration, chronic traumatic encephalopathy, and dementias associated with head trauma, including dementia pugilistica, brain trauma, subdural hematoma, brain tumor, hypothyroidism, vitamin B₁₂ deficiency, intracranial radiation and disorders associated with repetitive head injury.

Alzheimer's Disease:

In a specific embodiment, the invention provides a method of treating Alzheimer's disease, comprising administering to an animal in need of such treatment an effective amount of a compound or composition of the present invention. A detailed set of criteria for the diagnosis of Alzheimer's is set forth in the Diagnostic and Statistical Manual of Mental Disorders (Fourth Edition, text revision (2000), also known as the DSM-IV-TR). First, multiple cognitive deficits must be present, one of which must be memory impairment. Second, one or more of the following must be present: aphasia (deterioration of language abilities); apraxia (difficulty executing motor activities—even though movement, senses, and the ability to understand what is being asked are still intact); or agnosia (impaired ability to recognize or identify objects—even though sensory abilities are intact).

Amyotrophic Lateral Sclerosis:

In another specific embodiment, the invention provides a method of treating amyotrophic lateral sclerosis, comprising administering to an animal in need of such treatment an effective amount of a compound or composition of the present invention.

Amyotrophic lateral sclerosis (ALS), often referred to as “Lou Gehrig's Disease,” is a progressive neurodegenerative disease that affects nerve cells. Motor neurons reach from the brain to the spinal cord and from the spinal cord to the muscles throughout the body. As motor neurons degenerate, they can no longer send impulses to the muscle fibers that normally result in muscle movement.

Early symptoms of ALS often include increasing muscle weakness, especially involving the arms and legs, speech, swallowing or breathing. The progressive degeneration of the motor neurons in ALS eventually leads to their death. When the motor neurons die, the ability of the brain to initiate and control muscle movement is lost. With voluntary muscle action progressively affected, patients in the later stages of the disease may become totally paralyzed.

Movement Disorders:

In other embodiments, the invention provides a method of treating a movement disorder, comprising administering to an animal in need of such treatment an effective amount of a compound or composition of the present invention. In one aspect, the movement disorder includes one or more of the following: Huntington's disease, Parkinson's disease, an essential tremor, a Lewy body disease, hypokinetic disease, Multiple Sclerosis, various types of Peripheral Neuropathy, dystonia, a basal ganglia disorder, hypokinesia (including akinesia), and dyskinesia. In addition, Tourette's syndrome and other tic disorders can be included as categories of movement disorders. The utility of MAO inhibitors in the treatment of movement disorders is known in the literature. See, e.g., Waters, 2005, Other pharmacological treatments for motor complications and dyskinesias, Mov. Disord. 20 Suppl 11, S38-S44; Pearce et al., 2002, The monoamine reuptake blocker brasofensine reverses akinesia without dyskinesia in MPTP-treated and levodopa-primed common marmosets, Mov. Disord. 17, 877-886.

In related embodiment, the invention provides a method of treating chorea, comprising administering to an animal in need of such treatment an effective amount of a compound or composition of the present invention. Chorea can occur in a variety of conditions and disorders, and is a primary feature of Huntington's disease, a progressive neurological disorder. See, e.g., Mann and Chiu, 1978, Platelet monoamine oxidase activity in Huntington's chorea, J. Neurol. Neurosurg. Psychiatry 41, 809-812.

Huntington's Disease:

In a specific embodiment, the present invention provides a method of treating Huntington's disease, comprising administering to an animal in need of such treatment an effective amount of a compound or composition of the present invention.

Huntington's Disease (HD, or Huntington chorea) is a disorder passed down through families in which nerve cells in certain parts of the brain waste away, or degenerate. It is caused by a genetic defect on chromosome 4, causing a CAG repeat, to occur many more times than normal. The CAG element is normally repeated 10 to 28 times, but in persons with Huntington's disease, is repeated 36 to 120 times.

There are two forms of Huntington's disease: adult-onset Huntington's disease—which is the most common form and usually begins in the mid 30s and 40s; and early-onset Huntington's disease, which accounts for a small number of cases and begins in childhood or adolescence.

Symptoms of Huntington's disease include behavioral changes, abnormal and unusual movements, and worsening dementia. Behavioral changes may include behavioral disturbances, hallucinations, irritability, moodiness, restlessness or fidgeting, paranoia, and psychosis. Abnormal and unusual movements include facial movements, such as grimaces; head turning to shift eye position; quick, sudden, sometimes wild jerking movements of the arms, legs, face, and other body parts; slow, uncontrolled movements; and unsteady gait. Worsening dementia includes; disorientation or confusion; loss of judgment; loss of memory; personality changes; and speech changes. See, e.g., Dumas et al., 2013, A review of cognition in Huntington's disease, Front. Biosci. (Schol. Ed.) 5, 1-18. The utility of MAO-B inhibitors in treating Huntington's disease is known in the art. See, e.g., Messer et al., 2011. Up-regulation of the isoenzymes MAO-A and MAO-B in the human basal ganglia and pons in Huntington's disease revealed by quantitative enzyme radioautography, Brain Res. 1370, 204-214.

Parkinson's Disease:

In a specific embodiment, the present invention provides a method of treating Parkinson's disease, comprising administering to an animal in need of such treatment an effective amount of a compound or composition of the present invention.

Parkinson's disease (PD) (also known as Parkinson's, idiopathic parkinsonism, primary parkinsonism, PD, hypokinetic rigid syndrome/HRS, or paralysis agitans) is a degenerative disorder of the central nervous system estimated to afflict five million people worldwide. It is a slowly progressive neurological condition, characterized by tremors, stiffness, slowness of movement (bradykinesia) and impaired balance. Dopaminergic neurons decline steadily in PD, with motor symptoms emerging when about 50% of nigral neurons have degenerated. Bernheimer et al., 1973, Brain dopamine and the syndromes of Parkinson and Huntington: clinical, morphological and neurochemical correlations, J. Neurol. Sci. 20, 415-455. At disease presentation, there is approximately a 70-80% loss of striatal dopamine concentration. Fearnley and Lees, 1991, Aging and Parkinson's disease: substantia nigra regional selectivity, Brain 114, 2283-2301.

More generally, MAO-B levels increase with age, with post mortem brain samples showing increases of 41.5 and 30.4% in the putamen and globus pallidus lateralis, respectively, between 60 and 90 years of age. Saura et al., 1997, Biphasic and region specific MAO-B response to aging in normal human brain, Neurobiol. Aging 18, 497-507.

Hence MAO-B inhibitors lead to an increase in natural dopamine levels in the brain as well as an increase in dopamine levels produced from levodopa (which is a dopamine precursor and is metabolized to dopamine by aromatic amino acid decarboxylase) and are one of the mainstays in the treatment of PD.

In another aspect, the invention provides a method of treating Parkinson's disease with one or more agents useful in treating Parkinson's diseases, for example, L-DOPA; a dopaminergic agonist; a DOPA decarboxylase inhibitor (DCI); or a catechol-O-methyltransferase (COMT) inhibitor.

In another embodiment, the invention provides a method of treating myoclonus, Gilles de Ia Tourette's syndrome, dystonia, or tics, comprising administering to an animal in need of such treatment an effective amount of a compound or composition of the present invention. The utility of MAO inhibitors in the treatment of myoclonus, Tourette's syndrome, dystonia and tics is known in the literature. See, e.g., Jankovic and Beach, 1997, Long-term effects of tetrabenazine in hyperkinetic movement disorders, Neurology 48, 358-362.

A specific embodiment of the invention is a method of treating myoclonus, Gilles de La Tourette's syndrome, dystonia, or tics, comprising administering to an animal in need of such treatment an effective amount of a compound or composition of the present invention. The utility of MAO inhibitors in the treatment of myoclonus, Tourette's syndrome, dystonia and tics is known in the literature. See, e.g., Jankovic and Beach, 1997, Long-term effects of tetrabenazine in hyperkinetic movement disorders, Neurology 48, 358-362.

In a specific aspect, a movement disorder also includes multiple sclerosis, basal ganglia disorders, hypokinesia, and dyskinesia.

Lewy Body Diseases:

In one embodiment, the present embodiment, the invention provides a method of treating a Lewy Body Disease, comprising administering to an animal in need of such treatment an effective amount of a compound or composition of the present invention. Lewy bodies appear as spherical masses that displace other cell components. The two morphological types are classical (brain stem) Lewy bodies and cortical Lewy bodies. A classical Lewy body is an eosinophilic cytoplasmic inclusion consisting of a dense core surrounded by a halo of 10-nm-wide radiating fibrils, the primary structural component of which is alpha-synuclein. In contrast, a cortical Lewy body is less well defined and lacks the halo. Nonetheless, it is still made up of alpha-synuclein fibrils. Cortical Lewy bodies are a distinguishing feature of Dementia with Lewy bodies (DLB), but may occasionally be seen in ballooned neurons characteristic of Pick's disease and corticobasal degeneration, as well as in patients with other tauopathies.

More particularly, the Lewy Body disorder is selected from the group consisting of multiple system atrophy, particularly the Parkinsonian variant; Parkinson disease without or with dementia (PDD); dementia with LBs (DLB) alone or in association with Alzheimer disease (AD); multiple system atrophy, particularly the Parkinsonian variant, as well as Pick's disease and corticobasal degeneration.

Multiple Sclerosis:

In one embodiment, the present invention provides a method of treating a motor symptom associated with multiple sclerosis (MS), comprising administering to animal in need thereof an effective amount of a compound or composition of the present invention. MS is an autoimmune, demyelinating disease that affects the brain and spinal cord of the CNS. It affects women more than men and is most commonly diagnosed between ages 20 and 40, but can be seen at any age.

MS is caused by damage to the myelin sheath, the protective covering that surrounds nerve cells. When this nerve covering is damaged, nerve signals slow down or stop. Because nerves in any part of the brain or spinal cord may be damaged, patients with multiple sclerosis can have symptoms in many parts of the body. Symptoms vary, because the location and severity of each attack can be different. Episodes can last for days, weeks, or months. These episodes alternate with periods of reduced or no symptoms (remissions).

Muscle symptoms associated with MS include loss of balance; muscle spasms; numbness, tingling, or abnormal sensation in any area; problems moving arms or legs; problems walking; problems with coordination and making small movements; tremor in one or more arms or legs; and weakness in one or more arms or legs.

Basal Ganglia Disorders:

In particular embodiments, the present invention provides a method of treating a basal ganglia disorder comprising administering to an animal in need of such treatment an effective amount of a compound or composition of the present invention. Basal ganglia disorders refer to a group of physical dysfunctions that occur when the group of nuclei in the brain known as the basal ganglia fail to properly suppress unwanted movements or to properly prizzme upper motor neuron circuits to initiate motor function. See Purves et al., 2008, Neuroscience (4^{th} ed.). Sunderland Mass.: Sinauer Associates.

Increased output of the basal ganglia inhibits thalamocortical projection neurons. Proper activation or deactivation of these neurons is an integral component for proper movement. If something causes too much basal ganglia output, then the thalamocortical projection neurons become too inhibited and one cannot initiate voluntary movement. These disorders are known as hypokinetic disorders. However, a disorder leading to abnormally low output of the basal ganglia leads to relatively no inhibition of the thalamocortical projection neurons. This situation leads to an inability to suppress unwanted movements. These disorders are known as hyperkinetic disorders.

Hypokinesia:

In particular embodiments, the present invention provides a method of treating a hypokinesia comprising administering to an animal in need of such treatment an effective amount of a compound or composition of the present invention. Hypokinesia refers to decreased bodily movements, and they may be associated with basal ganglia diseases (such as Parkinson's disease), mental health disorders and prolonged inactivity due to illness, amongst other diseases.

More generally, hypokinesia describes a spectrum of disorders, including: (i) Akinesia, which refers to the inability to initiate movement due to difficulty selecting or activating motor programs in the central nervous system. Akinesia is a result of severely diminished dopaminergic cell activity in the direct pathway of movement and is common in severe cases of Parkinson's disease; (ii) Bradykinesia, which is characterized by slowness of movement and has been linked to Parkinson's disease and other disorders of the basal ganglia. Rather than being a slowness in initiation (akinesia), bradykinesia describes a slowness in the execution of movement. It is one of the 3 key symptoms of parkinsonism, which are bradykinesia, tremor and rigidity. Bradykinesia is also the cause of what is normally referred to as “stone face” (expressionless face) among those with Parkinson's; (iii) Freezing, which is characterized by an inability to move muscles in any desired direction; and (iv) Rigidity, which is characterized by an increase in muscle tone causing resistance to externally imposed joint movements; and (v) Postural instability, which is the loss of ability to maintain an upright posture.

Dyskinesia:

In particular embodiments, the present invention provides a method of treating a dyskinesia comprising administering to an animal in need of such treatment an effective amount of a compound or composition of the present invention. Dyskinesia is a movement disorder which consists of adverse effects including diminished voluntary movements and the presence of involuntary movements, similar to tics or chorea.

Dyskinesia can be anything from a slight tremor of the hands to uncontrollable movement of, most commonly, the upper body but can also be seen in the lower extremities. Discoordination can also occur internally especially with the respiratory muscles and it often goes unrecognized. Dyskinesia is a symptom of several medical disorders, distinguished by the underlying cause and generally corresponding to one of three types: acute dyskinesia, chronic (or tardive) dyskinesia, and non-motor dyskinesia.

More specifically, a dyskinesia can include one or more the following: paroxysmal dyskinesias, e.g., primary and secondary paroxysmal dyskinesias; paroxysmal kinesigenic dyskinesias (MD); paroxysmal non-kinesigenic dyskinesias (PNKD); paroxysmal exercise-induced (exertion-induced) dyskinesias (PED); and paroxysmal hypnogenic dyskinesias (PHD).

Trauma-Related Disorders:

In specific embodiments, the present invention provides a method of treating a trauma-related disorder, comprising administering to an animal in need of such treatment an effective amount of a compound or composition of the present invention.

In specific embodiments, trauma-related disorders comprise brain trauma; head trauma (closed and penetrating); head injury; tumors, especially cerebral tumors affecting the thalamic or temporal lobe head injuries; cerebrovascular disorders (diseases affecting the blood vessels in the brain), such as stroke, ischemia, hypoxia, and viral infection (e.g., encephalitis); excitotoxicity; and seizures; subdural hematoma; head injury; complications from Coronary Artery Bypass Graft (CABG) surgery; neurotoxicity. See, e.g., Huang et al., 1999, Neuroprotective effect of rasagiline, a selective monoamine oxidase-B inhibitor, against closed head injury in the mouse, Eur. J. Pharmacol. 366, 127-135. Such trauma-dependent injuries can result in a host of cognitive impairments, including deficits in learning, memory, language, and motor skills.

Conditions within the scope of the invention that are amenable to neuroprotection include: Stroke; traumatic brain injury (TBI); Dementia; Alzheimer's disease; Parkinson's disease; Huntington's disease; Cerebral palsy; Post-polio syndrome; Guillain-Barre syndrome, and Multiple Sclerosis; and other developmental syndromes, genetic conditions, and progressive CNS diseases affecting cognitive function, such as autism spectrum disorders, fetal alcohol spectrum disorders (FASD), Rubinstein-Taybi syndrome, Down syndrome, and other forms of mental retardation.

In another specific embodiment, the invention provides a method of treating a cognitive deficit associated with trauma. Such trauma-dependent loss of cognitive function include but are not limited to those due to cerebrovascular diseases, including stroke and ischemia, including ischemic stroke; brain trauma, including subdural hematoma and brain tumor; and head injury.

Such trauma-dependent losses also encompass cognitive impairments resulting from extrinsic agents such as alcohol use, long-term drug use, and neurotoxins such as lead, mercury, carbon monoxide, and certain insecticides

Psychiatric Disorders:

In a specific embodiment, the invention provides a method of treating a cognitive deficit associated with a psychiatric disorder, comprising administering to an animal in need of such treatment an effective amount of a compound or composition of the present invention. This category includes, but is not limited to, affective disorders (mood disorders), such as, but not limited to, depression and bipolar disorders, including depressive pseudodementia; psychotic disorders, such as, but not limited to, schizophrenia, delusional disorder and autism (Kanner's Syndrome); and neurotic and anxiety disorders, such as phobias, panic disorders, obsessive-compulsive disorder, generalized anxiety disorder, eating disorders, and posttraumatic stress disorders.

Developmental Syndromes, Genetic Disorders, and Progressive Diseases:

In a specific embodiment, the invention provides a method of treating a cognitive deficit associated with a developmental syndrome, genetic disorder, or progressive disease, comprising administering to an animal in need of such treatment an effective amount of a compound or composition of the present invention. This category includes, but is not limited to, autism spectrum disorder, a fetal alcohol spectrum disorder (FASD), Rubinstein-Taybi syndrome, Down syndrome, Angelman syndrome, Fragile X syndrome (Fragile X-1, Fragile X-2), neurofibromatosis, Coffin-Lowry syndrome, myotonic dystrophy, Rett syndrome, William's syndrome, Klinefelter's syndrome, mosaicisms, trisomy 13 (Patau's syndrome), trisomy 18 (Edward's syndrome), Turner's syndrome, cri du chat syndrome, Lesch-Nyhan syndrome (hyperuricemia), Hunter's syndrome, Lowe's oculocerebrorenal syndrome, Gaucher's disease, Hurler's syndrome (mucopolysaccharidosis), Niemann-Pick disease, Tay-Sachs disease, galactosemia, maple syrup urine disease, phenylketonuria, aminoacidurias, acidemias, tuberous sclerosis, primary microcephaly and other forms of mental retardation; and multiple sclerosis.

Cognitive Disorders:

In particular embodiments of the invention, the neurological disorder is a cognitive disorder. Accordingly, the present invention provides a method of treating a cognitive disorder, comprising administering to an animal in need of such treatment an effective amount of a compound or composition of the present invention. The utility of MAO inhibitors in the treatment of cognitive disorders is known in the literature. See, e.g., Schneider, 1998, New therapeutic approaches to cognitive impairment, J. Clin. Psychiatry 59, 8-13; U.S. 2007-0203154, U.S. 2011-0160248, U.S. 2010-0317648, and U.S. Pat. No. 8,222,243.

Cognitive disorders can significantly impair social and occupational functioning, adversely impacting the autonomy and quality of life of the affected individual. An estimated four to five million Americans (about 2% of all ages and 15% of those older than 65) have some form and degree of cognitive impairment. Abrams et al., 1995, Merck Manual of Geriatrics, Whitehouse Station (NJ), Medical Services.

Cognitive disorders reflect problems in cognition, i.e., the general processes by which knowledge is acquired, retained and used. Accordingly, cognitive disorders can encompass impairments in such functions as concentration, perception, attention, information processing, learning, memory, or language. Cognitive disorders can also encompass impairments in psychomotor learning abilities, which include physical skills, such as movement and coordination; fine motor skills such as the use of precision instruments or tools; and gross motor skills, such as dance, musical, or athletic performance.

Cognitive disorders also encompass impairments in executive functions, which include abilities underlying the planning and execution of goal-oriented behaviors. Such abilities include flexibility, i.e., the capacity for quickly switching to the appropriate mental mode; anticipation and prediction based on pattern recognition; reasoning and problem-solving; decision making; working memory, i.e., the capacity to hold and manipulate internally- or externally-derived information in real time; emotional self-regulation, including the ability to recognize and manage one's emotions for good performance; sequencing, such as the ability to dissect complex actions into manageable units and prioritize them in the right order; and self-inhibition, i.e., the ability to withstand distraction and internal urges.

Cognitive disorders also comprise cognitive impairments (deficits or dysfunctions) that are associated with (due to) to CNS disorders. In one aspect, a cognitive impairment can be a direct result of a CNS disorder. For example, impairments in speech and language can directly result from a stroke or head-injury that damages the brain regions controlling speech and language, as in aphasia.

In another aspect, a cognitive impairment is associated with a complex CNS disorder, condition, or disease. For example, a cognitive impairment can comprise a deficit in executive control that accompanies autism or mental retardation; a deficit in memory associated with schizophrenia or Parkinson's disease; or a cognitive deficit arising from multiple sclerosis. In the case of multiple sclerosis (MS), for example, about one-half of MS patients will experience problems with cognitive function, such as slowed thinking, decreased concentration, or impaired memory. Such problems typically occur later in the course of MS—although in some cases they can occur much earlier, if not at the onset of disease.

Cognitive impairments can be due to many, non-exclusive categories of CNS disorders, including the following (and as described herein):
(1) dementias, such as those associated with Alzheimer's disease, Parkinson's disease; Huntington's disease, Pick's disease, Creutzfeldt-Jakob, AIDS Dementia, and other neurodegenerative disorders; and cognitive disabilities associated with progressive diseases involving the nervous system, such as multiple sclerosis;
(2) psychiatric disorders, which include affective (mood) disorders, such as depression and bipolar disorders; psychotic disorders, such as schizophrenia and delusional disorder; and neurotic and anxiety disorders, such as phobias, panic disorders, obsessive-compulsive disorder, generalized anxiety disorder; eating disorders; and posttraumatic stress disorders;
(3) developmental syndromes, genetic conditions, and progressive CNS diseases affecting cognitive function, such as autism spectrum disorders; fetal alcohol spectrum disorders (FASD); Rubinstein-Taybi syndrome; Down syndrome, and other forms of mental retardation; and multiple sclerosis;
(4) trauma-dependent losses of cognitive functions, i.e., impairments in memory, language, or motor skills resulting from brain trauma; head trauma (closed and penetrating); head injury; tumors, especially cerebral tumors affecting the thalamic or temporal lobe; cerebrovascular disorders (diseases affecting the blood vessels in the brain), such as stroke, ischemia, hypoxia, and viral infection (e.g., encephalitis); excitotoxicity; and seizures. Such trauma-dependent losses also encompass cognitive impairments resulting from extrinsic agents such as alcohol use, long-term drug use, and neurotoxins, e.g., lead, mercury, carbon monoxide, and certain insecticides. See, e.g., Duncan et al., 2012, Monoamine oxidases in major depressive disorder and alcoholism, Drug Discover. Ther. 6, 112-122;
(5) age-associated cognitive deficits, including age-associated memory impairment (AAMI); also referred to herein as age-related memory impairment (AMI)), and deficits affecting patients in early stages of cognitive decline, as in Mild Cognitive Impairment (MCI); and
(6) learning, language, or reading disabilities, such as perceptual handicaps, dyslexia, and attention deficit disorders.

Accordingly, the invention provides a method of treating a cognitive impairment associated with a CNS disorder selected from one or more of the group comprising: dementias, including those associated with neurodegenerative disorders; psychiatric disorders; developmental syndromes, genetic conditions, and progressive CNS diseases and genetic conditions; trauma-dependent losses of cognitive function, age-associated cognitive deficits; and learning, language, or reading disorders.

Dementias:

In a specific embodiment, the invention provides a method of treating a cognitive deficit associated with dementia, comprising administering to an animal in need of such treatment an effective amount of a compound or composition of the present invention.

Dementias are neurodegenerative diseases characterized by learning and cognitive deficiencies and are typically accompanied by behavioral symptoms, psychological symptoms and motor symptoms. More particularly, dementia symptoms can include difficulty with many areas of mental function, including emotional behavior or personality, language, memory, perception, and thinking and judgment.

Dementias include, but are not limited to, the following: dementia due to Alzheimer's disease (with early or late onset), dementia due to Parkinson's disease, dementia due to Pick's disease, dementia due to Creutzfeldt-Jakob disease, dementia due to HIV disease, dementia due to head trauma; dementia due to a vascular disease (“vascular dementia”), Lewy body dementia, fronto-temporal dementia, Pick's disease and corticobasal degeneration.

In one embodiment, dementia is due to Alzheimer's disease. Accordingly, the present invention provides a method of treating dementia due to Alzheimer's disease, comprising administering to an animal in need of such treatment a therapeutically effective amount of a compound or composition of the present invention. The utility of MAO-B inhibitors in the treatment of Alzheimer's disease is known in the literature. See, e.g., Ono et al., 2006, Antiparkinsonian agents have anti-amyloidogenic activity for Alzheimer's beta-amyloid fibrils in vitro, Neurochem. Int. 48, 275-285. Accordingly, the invention provides a method of treating dementia due to Alzheimer's disease, comprising administering to an animal in need of such treatment a therapeutically effective amount of a compound or composition of the present invention.

In another embodiment, dementia is due to Parkinson's disease. Accordingly, the invention provides a method of treating dementia due to Parkinson's disease, comprising administering to an animal in need of such treatment a therapeutically effective amount of a compound or composition of the present invention. Dementia has been reported to occur in approximately 20%-60% of individuals with Parkinson's disease and is more likely to be present in older individuals or those with more severe or advanced disease. The dementia associated with Parkinson's disease is characterized by cognitive and motoric slowing; problems with executive functioning, such as planning tasks, organizing projects, or carrying out goals in the proper sequence; and impairment in memory retrieval. Declining cognitive performance in individuals with Parkinson's disease is frequently exacerbated by depression. The utility of MAO-B inhibitors in treating Parkinson's disease is known in the literature. See, e.g., Weinstock, et al., 2003, A novel cholinesterdas and brain-selective monoamine oxidase inhibitor for the treatment of dementia comorbid with depression and Parkinson's disease, Prog. Neuropsychopharmacol. Biol. Psychiatry 27, 555-561.

Dementia has been reported to occur in approximately 20%-60% of individuals with Parkinson's disease and is more likely to be present in older individuals or those with more severe or advanced disease. The dementia associated with Parkinson's disease is characterized by cognitive and motoric slowing, executive dysfunction, and impairment in memory retrieval. Declining cognitive performance in individuals with Parkinson's disease is frequently exacerbated by depression. For a review, Davie, 2008, A review of Parkinson's disease, Br. Med. Bull. 86, 109-127. The motor symptoms of Parkinson's disease result from the death of dopamine-generating cells in the substantia nigra, a region of the midbrain; the cause of this cell death is unknown. Early in the course of the disease, the most obvious symptoms are movement-related. Four motor symptoms are considered cardinal in PD: shaking (tremors), rigidity, slowness of movement, and postural instability, i.e., difficulty with walking and gait. See, e.g., Jankovic, 2008, Parkinson's disease: clinical features and diagnosis, J. Neurol. Neurosurg. Psychiatr. 79, 368-376. Later, cognitive and behavioral problems may arise, with dementia commonly occurring in the advanced stages of the disease. Other symptoms include sensory, sleep and emotional problems. PD is more common in the elderly, with most cases occurring after the age of 50.

In another aspect, a cognitive impairment is associated with a complex CNS syndrome, condition, or disease. For example, a cognitive impairment can comprise a deficit in executive control that accompanies autism or mental retardation; a deficit in memory associated with schizophrenia or Parkinson's disease; or a cognitive deficit arising from multiple sclerosis. In the case of multiple sclerosis (MS), for example, about one-half of MS patients will experience problems with cognitive function, such as slowed thinking, decreased concentration, or impaired memory. Such problems typically occur later in the course of MS—although in some cases they can occur much earlier, if not at the onset of disease.

In one aspect, a cognitive impairment can be a direct result of a CNS disorder. For example, impairments in speech and language can directly result from a stroke or head-injury that damages the brain regions controlling speech and language, as in aphasia.

Mental Retardation Syndromes:

In a specific embodiment, the invention provides a method of treating a mental retardation syndrome, comprising administering to an animal in need of such treatment an effective amount of a compound or composition of the present invention. Mental retardation impacts cognitive functions, including learning and memory acquisition. Syndromes in this category can have a genetic etiology, including many of the disorders in the preceding category, e.g., Rubinstein-Taybi syndrome, Down syndrome, Angelman syndrome, neurofibromatosis, Coffin-Lowry syndrome, Rett syndrome, myotonic dystrophy, Fragile X syndrome, and William's syndrome. In addition, mental retardation syndromes can be caused by congenital infections, teratogens (drugs and other chemicals), malnutrition, radiation or unknown conditions affecting implantation and embryogenesis.

Learning and Related Disabilities:

In a specific embodiment, the invention provides a method of treating a learning, language, or reading disability, comprising administering to an animal in need of such treatment an effective amount of a compound or composition of the present invention. This category includes perceptual handicaps, dyslexia and developmental aphasia. Such disabilities can be manifested difficulties in learning, memory retention, language, listening, thinking, talking, reading, writing, spelling, arithmetic or combinations of any of the foregoing.

In another embodiment, the present invention comprises normal patients who wish to improve their cognitive abilities. In a specific embodiment, the invention provides a method of improving a cognitive ability, comprising administering to an animal in need of such treatment an effective amount of a compound or composition of the present invention. Such patients include, but are not limited to, those wishing to improve the efficiency with which they complete a task or learn a new skill.

### Cognitive Training

An emerging notion is that most, if not all, cognitive domains can be functionally rehabilitated through focused “brain exercise.” The basic notion derives from the most fundamental property of the brain—its plasticity. Declarative memory is one manifestation of brain plasticity. Rehabilitation after stroke is another example of brain plasticity for implicit (motor) tasks. Buga et al. 2008, Rom. J. Morphol. Embryol. 49, 279-302. More generally, brain exercise as rehabilitation has a long history in animal models Merzenich et al. 1996, Cold Spring. Harb. Symp. Quant. Biol. 61, 1-8. More recently, this approach has been attempted in clinical studies with some success, including rehabilitation of working memory. Duerden and Laverdure-Dupont 2008, J. Neurosci. 28, 8655-8657; Mahncke et al. 2006, Prog. Brain Res. 157, 81-109; Neville and Bavelie 2002, Prog. Brain Res. 138, 177-188; Smith et al. 2009, J. Am. Geriatr. Soc. 57, 594-603; Tallal et al. 1998, Exp. Brain Res. 123, 210-219; Jaeggi et al. 2008, Proc. Natl. Acad. Sci. USA 105, 6829-6833.

Accordingly, in a preferred embodiment the present invention provides brain exercises (training protocols) that target distinct cognitive domains. Such protocols can cover multiple facets of cognitive ability, such as motor skills, executive functions, declarative memory, etc. Accompanying the training protocols are drug regiments for administering the augmenting agent. The present invention also provides programs that will collect and analyze performance data that is generated during implementation of the training protocols by ACT clinic workers.

In a preferred embodiment, the invention provides a software package comprising computer-based diagnostic tests and ACT protocols (brain exercise and drug regimens) to distribute (franchise) to the medical community.

In some embodiments, the compounds and compositions of the instant invention are administered in conjunction with cognitive training to improve the efficiency of such training. The phrase “in conjunction” means that a compound or composition of the present invention enhances CREB pathway function during cognitive training. As used herein, the term “cognitive training” is interchangeable with “training protocol,” “training,” and “cognitive training protocol.”

### Training Protocols

Training protocols are generally employed in rehabilitating individuals who have some form and degree of cognitive or motor dysfunction. For example, training protocols are commonly employed in stroke rehabilitation and in age-related memory loss rehabilitation. Because multiple training sessions are often required before an improvement or enhancement of a specific aspect of cognitive (or motor) performance (ability or function) is obtained in the individuals, training protocols are often very costly and time-consuming. Augmented training methods are more efficacious and therefore more cost-effective.

For example, human brain injury often results in motor and cognitive impairments. While advances in critical care medicine and patient management have led to improvements in patient outcome following traumatic brain injury (TBI), there is currently no known treatment to prevent the neuronal cell death and dysfunction that follows TBI. Although multiple treatments have proven neuroprotective in pre-clinical models of TBI, most have failed to show efficacy in humans.

Once a patient is stabilized following TBI, the standard of care dictates extensive motor or cognitive rehabilitation. During this rehabilitation the patient often regains lost skills, finally resulting in improved functional outcome. It would be beneficial if pharmaceutical treatments could be developed to enhance motor or cognitive rehabilitation following TBI, and thus improve functional outcome.

Cognitive training protocols and the underlying principles are well known in the art. See, e.g., U.S. Pat. No. 7,868,015 (and references cited therein); Klingberg et al., 2005, J. Am. Acad. Child. Adolesc. Psychiatry 44, 177-186; Belleville et al., 2006, Dement. Geriatr. Cogn. Disord. 22, 486-499; Jaeggi et al., 2008, Proc. Natl. Acad. Sci. USA 105, 6829-6833; Lustig et al., 2009, Neuropsychol. Rev. 19, 504-522; Park and Reuter-Lorenz, 2009, Ann. Rev. Psych. 60, 173-196; Chein et al., 2010, Psychon. Bull. Rev. 17, 193-199; Klingberg, 2010, Trends Cogn. Sci. 14, 317-324; Owen et al., 2010, Nature 465, 775-778; Jaeggi et al., 2011, Proc. Natl. Acad. Sci. USA 108, 10081-10086; Rider and Abdulahad, 1991, Percept. Mot. Skills 73, 219-224; Wek and Husak, 1989, Percept. Mot. Skills, 68, 107-113; Dean et al., 2000, Arch. Phys. Med. Rehabil. 81, 409-417; Hummelsheim and Eickhof, 1999, Scand. J. Rehabil. Med. 31, 250-256; Merzenich et al., 1996, Cold Spring Harb. Symp. Quant. Biol. 61, 1-8; Merzenich et al., 1996, Science 271, 77-81; Stewart et al., 2006, J. Neurol. Sci. 244, 89-95; Whitall et al., 2000, Stroke 31, 2390-2395; Tsao et al., 2010, J. Pain 11, 1120-1128; Oujamaa et al., 2009, Ann. Phys. Rehabil. Med. 52, 269-293; Frazzitta et al., 2009, Movement Disorders 8, 1139-1143; Jonsdottir et al., 2007, Neurorehabil. Neural Repair 21, 191-194; Krakauer, 2006, Curr. Opin. Neurol. 19, 84-90; Fischer et al., 2007, Top. Stroke Rehab. 14, 1-12; Volpe et al., 2008, Neurorehabil. Neural Repair 22, 305-310; Allen et al., 2012, Parkinsons Dis. 2012, 1-15.

Cognitive training protocols are directed to numerous cognitive dimensions, including memory, concentration and attention, perception, learning, planning, sequencing, and judgment. Motor training protocols can be directed to numerous motor domains, such as the rehabilitation of arm or leg function after a stroke or head injury. One or more protocols (or modules) underling a cognitive training program and/or motor training program can be provided to a subject.

In some embodiments, the protocols can be used to treat, or rehabilitate, cognitive impairments in afflicted subjects. Such protocols may be restorative or remedial, intended to reestablish prior skills and cognitive functions, or they may be focused on delaying or slowing cognitive decline due to neurological disease. Other protocols may be compensatory, providing a means to adapt to a cognitive deficit by enhancing function of related and uninvolved cognitive domains. In other embodiments, the protocols can be used to improve particular skills or cognitive functions in otherwise healthy individuals. For example, a cognitive training program might include modules focused on delaying or preventing cognitive decline that normally accompanies aging; here the program is designed to maintain or improve cognitive health.

In general, a cognitive training protocol (or module) comprises a set of distinct exercises that can be process-specific or skill-based. Responses to the exercises may be used to determine a score to evaluate the effectiveness of the training protocol.

Process-specific training focuses on improving a particular cognitive domain such as attention, memory, language, or executive functions. Here the goal of cognitive training is to obtain a general improvement that transfers from the trained activities to untrained activities associated with the same cognitive function or domain. For example, an auditory cognitive training protocol can be used to treat a student with impaired auditory attention. At the end of training, the student should show a generalized improvement in auditory attention, manifested by an increased ability to attend to and concentrate on verbal information presented in class—and therefore to remember to write down and complete homework assignments. Similarly, a cognitive training protocol may be directed to impaired executive function in an autistic subject, preventing the subject from carrying out instructions to complete an activity, such as making a meal, cleaning one's room, or preparing for school in the morning. Cognitive training allows the subject to focus his attention and concentration and as a result, complete the sequence of tasks required for such activities.

Skill-based cognitive training is aimed at improving performance of a particular activity or ability. Here the goal of cognitive training is to obtain a general improvement in the skill or ability. For example, a training protocol may focus on learning a new language, performing a musical instrument, improving memory, or learning a fine motor skill. The different exercises within such a protocol will focus on core components underlying skill. Modules for increasing memory, for example, may include tasks directed to the recognition and use of fact, and the acquisition and comprehension of explicit knowledge rules.

Some rehabilitation programs may rely on a single strategy (such as computer-assisted cognitive training) targeting either an isolated cognitive function or multiple functions concurrently. For example, the CogState testing method comprises a customizable range of computerized cognitive tasks able to measure baseline and change in cognitive domains underlying attention, memory, executive function, as well as language and social-emotional cognition. See, e.g., Yoshida et al., 2011, PloS ONE 6, e20469; Frederickson et al., 2010, Neuroepidemiology 34, 65-75. Other rehabilitation programs may use an integrated or interdisciplinary approach. Cognitive training programs may involve computer games, handheld game devices, interactive exercises, and may employ feedback and adaptive models.

### Neurorehabilitation and Neurorecovery

In other embodiments, the invention further relates to the use of compounds and compositions of the present invention in neurorecovery and neurorehabilitation, endogenous neurobiological processes that are central to recovery of cognitive and motor impairments of the nervous system. See, e.g., Harkema et al., 2012, Locomotor training: as a treatment of spinal cord injury and in the progression of neurologic rehabilitation, Arch. Phys. Med. Rehabil. 93, 1588-1597; Muresanu et al., 2012, Towards a roadmap in brain protection and recovery, J. Cell. Mol. Med. 16, 2861-2871.

Neurorehabilitation or neurorecovery generally refers to a collective process that focuses on aiding a person's recovery from a neurological disorder, or helping that individual to live a more normal, active, and independent life. For example, the quality of life of a person can be greatly affected by a brain or spinal cord injury, or a medical condition which affects the mobility, cognitive functions, or other physical or psychological processes that have been affected by changes in the nervous system. The goal of neurorehabilitation is to combat those changes and improve quality of life by various therapies.

Conditions within the scope of the invention that are treated by neurorehabilitation and neurorecovery include: Stroke; traumatic brain injury (TBI); Dementia; Alzheimer's disease; Parkinson's disease; Huntington's disease; Cerebral palsy; Post-polio syndrome; Guillain-Barre syndrome, and Multiple Sclerosis; and other developmental syndromes, genetic conditions, and progressive CNS diseases affecting cognitive function, such as autism spectrum disorders, fetal alcohol spectrum disorders (FASD), Rubinstein-Taybi syndrome, Down syndrome, and other forms of mental retardation.

By focusing on all aspects of a person's wellbeing, neurorehabilitation or neurorecovery offers a series of therapies from the psychological to occupational, teaching or re-training patients on mobility skills, communication processes, and other aspects of that person's daily routine. Neurorehabilitation or neurorecovery also provides focuses on nutrition, psychological, and creative parts of a person's recovery.

In one embodiment, the present invention provides a method of augmenting neurorehabilitation or neurorecovery from a cognitive impairment, comprising (a) providing cognitive training to a subject in need of treatment of a cognitive deficit under conditions sufficient to produce an improvement in performance by said animal of a cognitive function whose impairment is associated with said cognitive deficit; (b) administering a compound or composition of the present invention to the animal in conjunction with said cognitive training; repeating steps (a) and (b) one or more times; and (d) producing a long-lasting improvement in performance of said function relative to the improvement in performance of said function produced by cognitive training alone.

In another embodiment, the present invention provides a method of augmenting neurorehabilitation or neurorecovery from a motor impairment, comprising: (a) providing motor training to a subject in need of treatment of a motor deficit under conditions sufficient to produce an improvement in performance by said animal of a motor function whose impairment is associated with said cognitive deficit; (b) administering a compound or composition of the present invention to the animal in conjunction with said motor training; repeating steps (a) and (b) one or more times; and (d) reducing the number of training sessions sufficient to produce the improvement in performance, relative to the same improvement in performance produced by motor training alone.

### Augmented Cognitive Training

Cognitive training generally requires multiple training sessions to attain the desired benefits. This can be costly and time-consuming, deterring subject compliance and the realization of real world benefits that endure over time. In certain embodiments, a compound or composition of the present invention is used as an augmenting agent in methods to enhance the efficiency of cognitive or motor training (collectively “training”). Such enhancement methods are collectively known as “augmented training,” comprising “augmented cognitive training” or “augmented motor training.”

Training generally requires multiple sessions to attain the desired benefits, for example, to rehabilitate a motor deficit or language deficit following stroke. This can be costly and time-consuming, deterring subject compliance and the realization of real world benefits that endure over time. The efficiency of such training protocols can be improved by administering certain agents (known as augmenting agents) in conjunction with the training protocol. See, e.g., U.S. Pat. No. 7,868,015; U.S. Pat. No. 7,947,731; US 2008-0188525. Augmented training comprises a specific training protocol for a particular brain function, such as that underlying declarative memory, performance of a fine motor skill, locomotion, language acquisition, an executive function, etc., and a general administration of CREB pathway-enhancing drugs. The training protocol (cognitive or motor training) induces neuronal activity in specific brain regions and produces improved performance of a specific brain (cognitive or motor) function.

In some embodiments, the invention provides methods of treating a cognitive disorder, and more particularly, methods for improving a cognitive deficit associated with a central nervous system (CNS) disorder or condition in an animal, comprising administering the animal in need of such treatment an effective amount of with a compound or composition of the present invention that enhances CREB pathway function in conjunction with cognitive training. The efficiency of cognitive training can be improved by administering certain agents (known as augmenting agents) in conjunction with cognitive training. Such augmenting agents have the ability to enhance CREB pathway function. More particularly, this method (known as augmented cognitive training or ACT) can decrease the number of training sessions required to improve performance of a cognitive function, relative to the improvement observed by cognitive training alone. See, e.g., U.S. Pat. No. 7,868,015; U.S. Pat. No. 7,947,731; U.S. 2008/0051437.

In a particular embodiment, the method comprises the steps of: (a) providing cognitive training to a subject in need of treatment of a cognitive deficit under conditions sufficient to produce an improvement in performance by said animal of a cognitive function whose impairment is associated with said cognitive deficit; (b) administering a compound or composition of the present invention to the animal in conjunction with said cognitive training; repeating steps (a) and (b) one or more times; and (d) reducing the number of training sessions sufficient to produce the improvement in performance, relative to the same improvement in performance produced by cognitive training alone.

In another aspect, the method comprises: (a) providing cognitive training to a subject in need of treatment of a cognitive deficit under conditions sufficient to produce an improvement in performance by said animal of a cognitive function whose impairment is associated with said cognitive deficit; (b) administering a compound or composition of the present invention to the animal in conjunction with said cognitive training; repeating steps (a) and (b) one or more times; and (d) producing a long-lasting improvement in performance of said function relative to the improvement in performance of said function produced by cognitive training alone.

More generally, compounds and compositions of the present invention can be used in conjunction with any therapeutic approach that is intended to modulate cognitive function in the brain, thereby enhancing the efficacy of the such therapy by reducing the number of sessions—and hence time—necessary to attain benefits.

In one aspect, a compound or composition of the present invention can be used as an augmenting agent in conjunction with any psychotherapeutic approach intended to modulate cognitive function in the brain, thereby enhancing the efficacy of such therapy by reducing the number of sessions necessary to attain benefits.

In another specific aspect, the cognitive deficit treated by these methods is or includes memory impairment, and more particularly, a defect in long-term memory. Long-term memory (LTM) generally comprises two main biological properties. First, formation of long-term memory requires synthesis of new proteins. Second, it involves cAMP-responsive transcription and is mediated through the cAMP-response element binding protein (CREB) family transcription factors. Accordingly, in some embodiments, compounds of the present invention are useful in enhancing memory formation in an animal, and more particularly, transcription-dependent memory. Also, compounds and compositions of the present invention can act as CREB-augmenting agents and are therefore useful in enhancing memory formation in an animal, and more particularly, transcription-dependent memory. Indeed, exemplary compounds of the present invention activate CREB in cell-based assays.

In some embodiments, the invention provides methods of treating a motor disorder, and more particularly, methods for improving a motor deficit associated with a central nervous system (CNS) disorder or condition in an animal comprising treating the animal with an augmenting agent that enhances CREB pathway function in conjunction with motor training. Methods are also provided herein for providing sustained improvement in a motor deficit associated with a central nervous system (CNS) disorder or condition in an animal in need of said treatment comprising administering to the animal a compound or composition of the present invention; and detecting said sustained improvement.

In one aspect, the method comprises: (a) providing motor training to a subject in need of treatment of a motor deficit under conditions sufficient to produce an improvement in performance by said animal of a motor function whose impairment is associated with said cognitive deficit; (b) administering a compound or composition of the present invention to the animal in conjunction with said motor training; repeating steps (a) and (b) one or more times; and (d) reducing the number of training sessions sufficient to produce the improvement in performance, relative to the same improvement in performance produced by motor training alone.

In another aspect, the method comprises: (a) providing motor training to a subject in need of treatment of a motor deficit under conditions sufficient to produce an improvement in performance by said animal of a motor function whose impairment is associated with said cognitive deficit; (b) administering a compound or composition of the present invention to the animal in conjunction with said motor training; repeating steps (a) and (b) one or more times; and (d) producing a long-lasting improvement in performance of said function relative to the improvement in performance of said function produced by motor training alone.

In other embodiments, the invention provides methods for enhancing a specific aspect of cognitive performance in an otherwise healthy animal (particularly in a human or other mammal or vertebrate) comprising (a) administering to the animal an augmenting agent of the present invention; and (b) training the animal under conditions sufficient to produce an improvement in performance of a particular cognitive task by the animal. In other embodiments, the present invention provides methods of enhancing cognitive or motor performance, as well as methods for repeated stimulation of neuronal activity or a pattern of neuronal activity, such as that underlying a specific neuronal circuit(s).

In preferred embodiments, the clinics of the present invention provide treatment programs based on Augmented Cognitive Training (ACT), providing a specific training protocol, or brain exercise, in conjunction with administration of needed to yield a performance gain relative to that yielded with training alone. See U.S. Pat. Nos. 7,947,731; 7,868,015; 8,097,647; and 8,153,646 and U.S. patent application Ser. No. 10/410,508, and Ser. No. 12/041,188, all which are incorporated herein in their entireties.

In particular, ACT can enhance cognitive training by reducing the number of training sessions required to yield a performance gain relative to that yielded with cognitive training alone or by requiring shorter or no rest intervals between training sessions to yield a performance gain. In this manner, ACT can improve the efficiency of cognitive training techniques, thereby yielding significant economic benefit. By “performance gain” is meant an improvement in an aspect of cognitive performance.

In a preferred embodiment, ACT comprises a specific training protocol for each brain function and administration of CREB pathway-enhancing drugs. In an alternative embodiment, ACT comprises a skill-specific protocol, such as that required to learn an instrument, and general administration of an augmenting agent that enhances CREB pathway function

Administration of a CREB pathway enhancing drug acts via a general molecular mechanism of synaptic plasticity, which apparently converts the biochemical effect of a newly acquired experience into a long-lasting structural change of the synapse. Administration of a CREB pathway enhancing drug can be applied for any aspect of brain function that shows a lasting performance gain after cognitive training. Accordingly, administration of a CREB pathway enhancing drug can be used in rehabilitating an animal with any form of cognitive or motor dysfunction or in enhancing or improving any aspect of normal cognitive or motor performance in an animal.

A growing body of evidence suggests that neurons continue to proliferate in the adult brain (Arsenijevic et al. 2001, Exp. Neurol. 170, 48-62; Vescovi et al. 2001, Biomed. Pharmacother. 55:201-205; Cameron and McKay 2001, J. Comp. Neurol. 435, 406-417; and Geuna et al. 2001, Anat. Rec. 265, 132-141) and that such proliferation is in response to various experiences (Nilsson et al. 1999, J. Neurobiol. 39, 569-578; Gould et al. 1999, Trends Cogn. Sci., 3, 186-192; Fuchs and Gould 2000, E. Eur. J. Neurosci. 12, 2211-2214; Gould et al. 2000, Biol. Psychiatry 48, 715-720; and Gould et al. 1999, Nat. Neurosci., 2, 260-265). Experimental strategies now are underway to transplant neuronal stem into adult brain for various therapeutic indications (Kurimoto et al. 2001, Neurosci. Lett. 306, 57-60; Singh 2001, Neuropathology 21, 110-114; and Cameron and McKay 1999, Nat. Neurosci., 2, 894-897). Much already is known about neurogenesis in embryonic stages of development (Saitoe and Tully 2000, Toward a Theory of Neuroplasticity, J. McEachem and C. Shaw, Eds. (New York: Psychology Press.) 193-220). Neuronal differentiation, neurite extension and initial synaptic target recognition all appear to occur in an activity-independent fashion. Subsequent synaptogenesis and synaptic growth, however, then requires ongoing neuronal activity to fine-tune synaptic connections in a functionally relevant manner.

These findings suggest that functional (final) integration of transplanted neural stem cells require neuronal activity. Thus, administration of a CREB pathway enhancing drug can be used to exercise appropriate neuronal circuits to fine-tune the synaptic connections of newly acquired, transplanted stem cells that differentiate into neurons. By “exercise appropriate neuronal circuit(s)” is meant the induction in the appropriate neuronal circuit(s) of a pattern of neuronal activity, which corresponds to that produced by a particular cognitive training protocol. The cognitive training protocol can be used to induce such neuronal activity. Alternatively, neuronal activity can be induced by direct electrical stimulation of the neuronal circuitry. “Neuronal activity” and “neural activity” are used interchangeably herein.

By “enhance CREB pathway function” is meant the ability to enhance or improve CREB-dependent gene expression. CREB-dependent gene expression can be enhanced or improved by increasing endogenous CREB production, for example by directly or indirectly stimulating the endogenous gene to produce increased amounts of CREB, or by increasing functional (biologically active) CREB. See, e.g., U.S. Pat. No. 5,929,223; U.S. Pat. No. 6,051,559; and International Publication No. WO9611270 (published Apr. 18, 1996), which are incorporated herein in their entirety by reference.

### Protocols to Stimulate Neural Activity

In various embodiments, training protocols, or “brain exercises” are used to stimulate neural activity or brain circuitry. Alternative methods to stimulate brain circuitry other than by brain exercise (behavioral), include trans-cranial magnetic stimulation (Song et al. 2009, Low-frequency transcranial magnetic stimulation for visual spatial neglect: a pilot study, J. Rehabil. Med. 41, 162-165).

Training protocols are known and readily available in the art. See, for example, Karni, A. and Sagi, D., “Where practice makes perfect in text discrimination: evidence for primary visual cortex plasticity”, Proc. Natl. Acad. Sci. USA, 88:4966-4970 (1991); Karni, A. and Sagi, D., “The time course of learning a visual skill”, Nature, 365:250-252 (1993); Kramer, A. F. et al., “Task coordination and aging: explorations of executive control processes in the task switching paradigm”, Acta Psychol. (Amst), 101:339-378 (1999); Kramer, A. F. et al., “Training for executive control: Task coordination strategies and aging”, In Aging and Skilled Performance: Advances In Theory and Applications, W. Rogers et al., eds. (Hillsdale, N.J.: Erlbaum) (1999); Rider, R. A. and Abdulahad, D. T., “Effects of massed versus distributed practice on gross and fine motor proficiency of educable mentally handicapped adolescents”, Percept. Mot. Skills, 73:219-224 (1991); Willis, S. L. and Schaie, K. W., “Training the elderly on the ability factors of spatial orientation and inductive reasoning”, Psychol. Aging, 1:239-247 (1986); Willis, S. L. and Nesselroade, C. S., “Long-term effects of fluid ability training in old-old age”, Develop. Psychol., 26:905-910 (1990); Wek, S. R. and Husak, W. S., “Distributed and massed practice effects on motor performance and learning of autistic children”, Percept. Mot. Skills, 68:107-113 (1989); Verhaehen, P. et al., “Improving memory performance in the aged through mnemonic training: a meta-analytic study”, Psychol. Aging, 7:242-251 (1992); Verhaeghen, P. and Salthouse, T. A., “Meta-analyses of age-cognition relations in adulthood: estimates of linear and nonlinear age effects and structural models”, Psychol. Bull., 122:231-249 (1997); Dean, C. M. et al., “Task-related circuit training improves performance of locomotor tasks in chronic stroke: a randomized, controlled pilot trial”, Arch. Phys. Med. Rebabil., 81:409-417 (2000); Greener, J. et al., “Speech and language therapy for aphasia following stroke”, Cochrane Database Syst. Rev., CD000425 (2000); Hummelsheim, H. and Eickhof, C., “Repetitive sensorimotor training for arm and hand in a patient with locked-in syndrome”, Scand. J. Rehabil, Med., 31:250-256 (1999); Johansson, B. B., “Brain plasticity and stroke rehabilitation. The Willis lecture”, Stroke, 31:223-230 (2000); Ko, C., “Effectiveness of rehabilitation for multiple sclerosis”, Clin. Rehabil., 13 (Suppl. 1):33-41 (1999); Lange, G. et al., “Organizational strategy influence on visual memory performance after stroke: cortical/subcortical and left/right hemisphere contrasts”, Arch. Phys. Med. Rehabil., 81:89-94 (2000); Liepert, J. et al., “Treatment-induced cortical reorganization after stroke in humans”, Stroke, 31:1210-1216 (2000); Lotery, A. J. et al., “Correctable visual impairment in stroke rehabilitation patients”, Age Ageing, 29:221-222 (2000); Majid, M. J. et al., “Cognitive rehabilitation for memory deficits following stroke” (Cochrane review), Cochrane Database Syst. Rev., CD002293 (2000); Merzenich, M. et al., “Cortical plasticity underlying perceptual, motor, and cognitive skill development: implications for neurorehabilitation”, Cold Spring Harb. Symp. Quant. Biol., 61:1-8 (1996); Merzenich, M. M. et al., “Temporal processing deficits of language-learning impaired children ameliorated by training”, Science, 271:77-81 (1996); Murphy, E., “Stroke rehabilitation”, J. R. Coll. Physicians Lond., 33:466-468 (1999); Nagaraj an, S. S. et al., “Speech modifications algorithms used for training language learning-impaired children”, IEEE Trans. Rehabil. Eng., 6:257-268. (1998); Oddone, E. et al., “Quality Enhancement Research Initiative in stroke: prevention, treatment, and rehabilitation”, Med. Care 38:192-1104 (2000); Rice-Oxley, M. and Turner-Stokes, L., “Effectiveness of brain injury rehabilitation”, Clin. Rehabil., 13(Suppl 1):7-24 (1999); Tallal, P. et al., “Language learning impairments: integrating basic science, technology, and remediation”, Exp. Brain Res., 123:210-219 (1998); Tallal, P. et al., “Language comprehension in language-learning impaired children improved with acoustically modified speech”, Science, 271:81-84 (1996); Wingfield, A. et al., “Regaining lost time, adult aging and the effect of time restoration on recall of time-compressed speech”, Psychol. Aging, 14:380-389 (1999), all of which are incorporated herein in their entirety by reference.

Training protocols can comprise one or multiple training sessions and are customized to produce an improvement in performance of the cognitive task of interest. For example, if an improvement in language acquisition is desired, training would focus on language acquisition. If an improvement in ability to learn to play a musical instrument is desired, training would focus on learning to play the musical instrument. If an improvement in a particular motor skill is desired, training would focus on acquisition of the particular motor skill. The specific cognitive task of interest is matched with appropriate training.

By “multiple training sessions” is meant two or more training sessions. The augmenting agent can be administered before, during or after one or more of the training sessions. In a particular embodiment, the augmenting agent is administered before and during each training session. Treatment with augmenting agent in connection with each training session is also referred to as the “augmenting treatment.” By “training” is meant cognitive training or other therapy to improve nervous system function.

In one embodiment, training protocols are employed in treating patients with depression (monopolor) and/or phobias to help them unlearn pathological responses associated with the depression and/or phobia(s) and learn appropriate behavior. Administration of a CREB pathway-enhancing drug optionally in conjunction with cognitive training reduces the time and/or number of training sessions required to yield a gain in performance in these patients. As such, overall treatment is accomplished in a shorter period of time.

In another embodiment, training protocols are employed in treating patients with autism to help them unlearn pathological responses and to learn appropriate behavior. Accordingly, administration of a CREB pathway-enhancing drug optionally in conjunction with cognitive training reduces the time and/or number of training sessions required to yield a gain in performance in these patients.

In another embodiment, training protocols (e.g., physical therapy, bio-feedback methods) are employed in treating stroke patients after the acute phase has ended and the patient has been stabilized, and in particular, to rehabilitate impaired or lost sensory-motor function(s). Administration of a CREB pathway-enhancing drug in conjunction with cognitive training reduces the time and/or number of training sessions required to yield a gain in performance in these patients. Faster and more efficient recovery of lost cognitive or motor function(s) are expected as a result.

In another embodiment, training protocols (e.g., massed training, spaced training) are employed in treating patients, who may show no cognitive impairments, but who wish to learn a new language or a skill, such as learning to play a new musical instrument. Administration of a CREB pathway-enhancing drug in conjunction with cognitive training reduces the time and/or number of training sessions required to yield a gain in performance. As a result, less practice (training sessions) is required to learn the new language or to learn to play the new musical instrument.

In another embodiment, training protocols are employed in improving learning and/or performance in patients with learning disabilities. Administration of a CREB pathway-enhancing drug in conjunction with cognitive training reduces the time and/or number of training sessions required to yield a gain in performance in these individuals.

In another aspect, training protocols are employed to exercise neuronal circuits in patients to fine-tune synaptic connections of newly acquired, transplanted stem cells that differentiate into neurons. Administration of a CREB pathway-enhancing drug in conjunction with cognitive training reduces the time and/or number of training sessions required for the induction in (a) specific neuronal circuit(s) of a pattern of neuronal activity in these individuals.

In another aspect, training protocols are employed for repeated stimulation of neuronal activity or a pattern of neuronal activity underlying (a) specific neuronal circuit(s) in patients. Administration of a CREB pathway-enhancing drug in conjunction with cognitive training reduces the time and/or number of training sessions and/or underlying pattern of neuronal activity required to induce CREB-dependent long-term structure/function (i.e., long-lasting) change among synaptic connections of the neuronal circuit.

### Augmenting Agents

Augmenting agents, as used herein, are compounds with pharmacological activity. They include the compounds and compositions that enhance CREB pathway function. By enhancing CREB pathway function in conjunction with training, such augmented training can decrease the number of training sessions required to improve performance of a cognitive or motor function, relative to the improvement observed by training alone. See, e.g., U.S. 2007-0203154, U.S. 2011-0160248, U.S. 2010-0317648, and U.S. Pat. No. 8,222,243. They include drugs, chemical compounds, ionic compounds, organic compounds, organic ligands, including cofactors, saccharides, recombinant and synthetic peptides, proteins, peptoids, nucleic acid sequences, including genes, nucleic acid products, and other molecules and compositions.

“Augmenting agents” are also referred to herein as “CREB pathway-enhancing drugs.” For example, augmenting agents can be cell permeant cAMP analogs (e.g., 8-bromo cAMP); activators of adenylate cyclase 1 (AC1) (e.g., forskolin); agents affecting G-protein linked receptor, such as, but not limited to adrenergic receptors and opioid receptors and their ligands (e.g., phenethylamines); modulators of intracellular calcium concentration (e.g., thapsigargin, N-methyl-D-aspartate (NMDA) receptor agonists); inhibitors of the phosphodiesterases responsible for cAMP breakdown (e.g., phosphodiesterase 1 (PDE1) inhibitors (e.g., iso-buto-metho-xanthine (IBMX)), phosphodiesterase 2 (PDE2) inhibitors (e.g., iso-buto-metho-xanthine (IBMX)), phosphodiesterase 3 (PDE3) inhibitors, phosphodiesterase 4 (PDE4) inhibitors (e.g., rolipram, HT0712), etc.) (see also, e.g., U.S. Pat. No. 6,458,829B1; U.S. Publication No. 2002/0028842A1 (published Mar. 7, 2002)); inhibitors of monoamine oxidase type B (MAO-B) and modulators of protein kinases and protein phosphatases, which mediate CREB protein activation and CREB-dependent gene expression. Augmenting agents can be exogenous CREB, CREB analogs, CREB-like molecules, biologically active CREB fragments, CREB fusion proteins, or nucleic acid sequences encoding exogenous CREB, CREB analogs, CREB-like molecules, biologically active CREB fragments or CREB fusion proteins.

Augmenting agents can also be CREB function modulators, or nucleic acid sequences encoding CREB function modulators. CREB function modulators, as used herein, have the ability to modulate CREB pathway function. By “modulate” is meant the ability to change (increase or decrease) or alter CREB pathway function.

Augmenting agents can be compounds which are capable of enhancing CREB function in the CNS. Such compounds include, but are not limited to, compounds which affect membrane stability and fluidity and specific immunostimulation. In a particular embodiment, the augmenting agent is capable of transiently enhancing CREB pathway function in the CNS.

CREB analogs, or derivatives, are defined herein as proteins having amino acid sequences analogous to endogenous CREB. Analogous amino acid sequences are defined herein to mean amino acid sequences with sufficient identity of amino acid sequence of endogenous CREB to possess the biological activity of endogenous CREB, but with one or more “silent” changes in the amino acid sequence. CREB analogs include mammalian CREM, mammalian ATF-1 and other CREB/CREM/ATF-1 subfamily members.

CREB-like molecule, as the term is used herein, refers to a protein which functionally resembles (mimics) CREB. CREB-like molecules need not have amino acid sequences analogous to endogenous CREB.

Biologically active polypeptide fragments of CREB can include only a part of the full-length amino acid sequence of CREB, yet possess biological activity. Such fragments can be produced by carboxyl or amino terminal deletions, as well as internal deletions.

Fusion proteins comprise a CREB protein as described herein, referred to as a first moiety, linked to a second moiety not occurring in the CREB protein. The second moiety can be a single amino acid, peptide or polypeptide or other organic moiety, such as a carbohydrate, a lipid or an inorganic molecule.

In particular embodiments, the augmenting agent is a phosphodiesterase 4 (PDE4) inhibitor. Examples of PDE4 inhibitors include rolipram and HT-0712, which are disclosed in U.S. patent application Ser. No. 10/410,508, which is incorporated herein in its entirety.

In another embodiment, the augmenting agent is a GalR3 receptor antagonist, such as those disclosed in U.S. Pat. No. 7,642,281, which is incorporated herein in its entirety.

Augmenting agents can enhance CREB pathway function by a variety of mechanisms. For example, an augmenting agent can affect a signal transduction pathway which leads to induction of CREB-dependent gene expression. Induction of CREB-dependent gene expression can be achieved, for example, via up-regulation of positive effectors of CREB function and/or down-regulation of negative effectors of CREB function. Positive effectors of CREB function include adenylate cyclases and CREB activators. Negative effectors of CREB function include cAMP phosphodiesterase (cAMP PDE) and CREB repressors.

An augmenting agent can enhance CREB pathway function by acting biochemically upstream of or directly acting on an activator or repressor form of a CREB protein and/or on a CREB protein containing transcription complex. For example, CREB pathway function can be affected by increasing CREB protein levels transcriptionally, post-transcriptionally, or both transcriptionally and post-transcriptionally; by altering the affinity of CREB protein to other necessary components of the of the transcription complex, such as, for example, to CREB-binding protein (CBP protein); by altering the affinity of a CREB protein containing transcription complex for DNA CREB responsive elements in the promoter region; or by inducing either passive or active immunity to CREB protein isoforms. The particular mechanism by which an augmenting agent enhances CREB pathway function is not critical to the practice of the invention.

Augmenting agents can be administered directly to a subject in a variety of ways including before, during or after one or more of the training sessions. In a particular embodiment, the augmenting agent is administered before and during each training session. Treatment with an augmenting agent in connection with each training session is also referred to as the “augmenting treatment”. In a preferred embodiment, augmenting agents are administered systemically. Other routes of administration are generally known in the art and include intravenous including infusion and/or bolus injection, intracerebroventricularly, intrathecal, parenteral, mucosal, implant, intraperitoneal, oral, intradermal, transdermal (e.g., in slow release polymers), intramuscular, subcutaneous, topical, epidural, etc. routes. Other suitable routes of administration can also be used, for example, to achieve absorption through epithelial or mucocutaneous linings Particular augmenting agents can also be administered by gene therapy, wherein a DNA molecule encoding a particular therapeutic protein or peptide is administered to the animal, e.g., via a vector, which causes the particular protein or peptide to be expressed and secreted at therapeutic levels in vivo.

The mode of administration is preferably at the location of the target cells. In a particular embodiment, the mode of administration is to neurons.

Augmenting agents can be administered together with other components of biologically active agents, such as pharmaceutically acceptable surfactants (e.g., glycerides), excipients (e.g., lactose), stabilizers, preservatives, humectants, emollients, antioxidants, carriers, diluents and vehicles. If desired, certain sweetening, flavoring and/or coloring agents can also be added.

Augmenting agents can be formulated as a solution, suspension, emulsion or lyophilized powder in association with a pharmaceutically acceptable parenteral vehicle. Examples of such vehicles are water, saline, Ringer's solution, isotonic sodium chloride solution, dextrose solution, and 5% human serum albumin Liposomes and nonaqueous vehicles such as fixed oils can also be used. The vehicle or lyophilized powder can contain additives that maintain isotonicity (e.g., sodium chloride, mannitol) and chemical stability (e.g., buffers and preservatives). The formulation can be sterilized by commonly used techniques. Suitable pharmaceutical carriers are described in Remington's Pharmaceutical Sciences.

The dosage of augmenting agent administered to a patient is that amount required to effect a change in CREB-dependent gene expression, particularly in neurons. The dosage administered to an animal, including frequency of administration, will vary depending upon a variety of factors, including pharmacodynamic characteristics of the particular augmenting agent, mode and route of administration; size, age, sex, health, body weight and diet of the recipient; nature and extent of symptoms being treated or nature and extent of the cognitive function(s) being enhanced or modulated, kind of concurrent treatment, frequency of treatment, and the effect desired.

Augmenting agents can be administered in single or divided doses (e.g., a series of doses separated by intervals of days, weeks or months), or in a sustained release form, depending upon factors such as nature and extent of symptoms, kind of concurrent treatment and the effect desired. Other therapeutic regimens or agents can be used in conjunction with the present invention.

All publications, patent and patent applications mentioned in this specification are incorporated herein by reference to the same extent as if each individual publication, patent or patent application was specifically and individually incorporated by reference.

While this invention has been particularly shown and described with references to preferred embodiments thereof, it will be understood by those skilled in the art that various changes in form and details may be made therein without departing from the scope of the invention encompassed by the appended claims. Further, the embodiments included herein are given solely for the purpose of illustration and are not to be construed as limitations of the present invention, as many variations thereof are possible without departing from the spirit and scope of the invention.

1-41. (canceled)

42. A digital device aided therapy to improve a nervous system function in a patient, comprising
a. Providing a digital device with access to a database including information on the patient and a training threshold;
b. Inputting a training procedure customized for the patient using the digital device;
c. Providing training procedure access using the digital device to the patient or a person overseeing the patient during the training procedure;
d. Recording the patient's execution of the training procedure;
e. Determining the training score from the patient's execution of the training procedure using the digital device;
f. Comparing the training score to the training threshold using the digital device; and
g. Repeating steps (b) to (f) if the digital device determines in step (f) that the training score is less than the training threshold.

43. The digital device aided therapy of claim 42 wherein the database comprises the patient's medical information.

44. The digital device aided therapy of claim 42 wherein the training procedure includes a training protocol for the patient, the training protocol including an exercise to which the patient submits a response that is used to produce the training score.

45. The digital device aided therapy of claim 42 wherein the training procedure includes an augmenting agent protocol including the name and dosage of the augmenting agent to be administered to the patient in conjunction with the training protocol.

46. The digital device aided therapy of claim 45 wherein the augmenting agent comprises one or more from the group consisting of a cell permeant cAMP analog, an adenylate cyclase 1 activator, an agent affecting G-protein linked receptor, a modulator of intracellular calcium concentration, a phosphodiesterase 1 (PDE1) inhibitor, a phosphodiesterase 2 (PDE2) inhibitor, a phosphodiesterase 3 (PDE3) inhibitor, a phosphodiesterase 4 (PDE4) inhibitor, a monoamine oxidase type B inhibitor (MAO-B), a GalR3 inhibitor, exogenous CREB, a CREB analog, a CREB-like molecule, a biologically active CREB fragment, a CREB fusion protein or a nucleic acid sequence encoding exogenous CREB, a CREB analog, a CREB-like molecule, a biologically active CREB fragment and a CREB fusion protein.

47. The digital device aided therapy of claim 44 further includes the digital device accessing a training protocol library, the training protocol library including the training protocol.

48. The digital device aided therapy of claim 45 wherein the augmenting agent protocol further includes instructions that the augmenting agent is to be administered to the patient before training the patient using the training procedure.

49. The digital device aided therapy of claim 45 wherein the augmenting agent protocol further includes instructions that the augmenting agent is to be administered to the patient during training the patient using the training procedure.

50. The digital device aided therapy of claim 45 wherein the augmenting agent protocol further includes instructions that the augmenting agent is to be administered to the patient after training the patient using the training procedure.

51. The digital device aided therapy of claim 42 wherein inputting the training procedure includes recording the training procedure in the database using the digital device.

52. The digital device aided therapy of claim 42 wherein recording the patient's execution of the training procedure includes
a. Inputting the patient's response to the training protocol exercise into the digital device; and
b. Recording in the database the patient's response to the training protocol exercise using the digital device.

53. The digital device aided therapy of claim 42 further including recording the training score in the database using the digital device.

54. The digital device aided therapy of claim 42 wherein the digital device comprises more than one digital device.

55. The digital device aided therapy of claim 54 wherein the more than one digital device includes a treatment server and a treatment device that are connected utilizing a communication network.

56. The digital device aided therapy of claim 55 wherein the treatment server includes the database.

57. The digital device aided therapy of claim 42, wherein the patient suffers from memory impairment, Alzheimer's disease, amyotrophic lateral sclerosis, Huntington's disease, Parkinson's disease, Lewy Body Disease, multiple sclerosis, basal ganglia disorder, hypokinesia, dyskinesia, a trauma-related disorder, a psychiatric disorder, a developmental syndrome, a genetic disorder, a progressive disease, a cognitive disorder, dementia, a mental retardation syndrome or a learning disability.

58. The digital device aided therapy of claim 42 further includes
a. Inputting a test procedure customized for the patient using the digital device;
b. Providing test procedure access using the digital device to the patient or a person overseeing the patient during the test procedure;
c. Recording the patient's execution of the test procedure; and
d. Determining the test score from the patient's execution of the test procedure.

59. The digital device aided therapy of claim 58 further includes determining the training threshold from the test score.

60. The digital device aided therapy of claim 58 further includes determining a revised training threshold from the test score.

61. The digital device aided therapy of claim 58 further includes recording the test score in the database.

62. The digital device aided therapy of claim 58 wherein determining the test score occurs before inputting the training procedure and is a pre-training test score.

63. The digital device aided therapy of claim 58 wherein determining the test score occurs after determining the training score and is a post-training test score.

64. The digital device aided therapy of claim 42 further includes accessing and analyzing the database prior to inputting the training procedure.

65. The digital device aided therapy of claim 64 wherein the step of accessing and analyzing the database includes accessing and analyzing the information of one patient.

66. The digital device aided therapy of claim 64 wherein the step of accessing and analyzing the database includes accessing and analyzing the information of more than one patient.

67. The digital device aided therapy of claim 42 wherein the nervous system includes a cognitive function or a motor function.

68. The digital device aided therapy of claim 42 further includes determining a revised training threshold from the training score.

69. A treatment system for improving a nervous system function in a patient, comprising
a. A database capable of storing data including patient data, augmenting agent data, training data and analyzed data;
b. A digital device including:
i. An input interface to enter data;
ii. A display interface to display data;
iii. A patient data module configured to receive patient data;
iv. An augmenting agent administration module configured to receive augmenting agent data;
v. A training module configured to receive training data;
vi. A communication module configured to provide communication between the digital device and the database; and
vii. An analysis module configured to perform analysis of the data and provide analyzed data.

70. The treatment system of claim 69 wherein the database includes a first database and second database.

71. The treatment system of claim 70 wherein the first database is remote from the second database.

72. The treatment system of claim 69 wherein the training data includes a training protocol for the patient, the training protocol including an exercise to which the patient submits a response that is used to produce a training score.

73. The treatment system of claim 69 wherein the augmenting agent data includes an augmenting agent protocol including the name and dosage of the augmenting agent to be administered to the patient in conjunction with the training protocol.

74. The treatment system of claim 73 wherein the augmenting agent comprises one or more of the group consisting of a cell permeant cAMP analog, an adenylate cyclase 1 activator, an agent affecting G-protein linked receptor, a modulator of intracellular calcium concentration, a phosphodiesterase 1 (PDE1) inhibitor, a phosphodiesterase 2 (PDE2) inhibitor, a phosphodiesterase 3 (PDE3) inhibitor, a phosphodiesterase 4 (PDE4) inhibitor, a monoamine oxidase type B inhibitor (MAO-B), a GalR3 inhibitor, exogenous CREB, a CREB analog, a CREB-like molecule, a biologically active CREB fragment, a CREB fusion protein or a nucleic acid sequence encoding exogenous CREB, a CREB analog, a CREB-like molecule, a biologically active CREB fragment and a CREB fusion protein.

75. The treatment system of claim 69 wherein the training data comprises a training protocol library including a training protocol.

76. The treatment system of claim 69 wherein the digital device includes a treatment server and a treatment device that are connected utilizing a communication network.

77. The treatment system of claim 69 wherein the database includes a treatment server and the digital device includes a treatment device.

78. The treatment system of claim 69 wherein the treatment system includes a first digital device and a second digital device.

79. The treatment system of claim 78 wherein the first digital device is remote from the second digital device.

80. The treatment system of claim 78 wherein the first digital device includes a communication module configured to provide communication among the first digital device, the second digital device and the database.

81. The treatment system of claim 78 wherein the second digital device includes a communication module to provide communication among the first digital device, the second digital device and the database.

82. The treatment system of claim 78 wherein
a. the first digital device includes:
i. A patient data module configured to receive patient data;
ii. An augmenting agent administration module configured to receive augmenting agent data;
iii. A training module configured to receive training data;
iv. A communication module configured to provide communication between the first digital device, the second digital device and the database; and
v. An analysis module configured to perform analysis of the data and provide analyzed data; and
b. the second digital device includes:
i. An input interface to enter data;
ii. A display interface to display data; and
iii. A communication module configured to provide communication between the first digital device and the second digital device.

83. The treatment system of claim 82 wherein the first digital device is remote from the second digital device.

84. The treatment system of claim 69, wherein the patient suffers from memory impairment, Alzheimer's disease, amyotrophic lateral sclerosis, Huntington's disease, Parkinson's disease, Lewy Body Disease, multiple sclerosis, basal ganglia disorder, hypokinesia, dyskinesia, a trauma-related disorder, a psychiatric disorder, a developmental syndrome, a genetic disorder, a progressive disease, a cognitive disorder, dementia, a mental retardation syndrome or a learning disability.
